(19) United States
(12) Patent Application Publication
(10) Pub. No.: US 2025/0324004 A1
(43) Pub. Date: Oct. 16, 2025

(54) IMAGE FORMING APPARATUS INCLUDING FRONT EXTERIOR COVER AND HINGE WHICH COUPLES THE EXTERIOR COVER WITH MAIN BODY

(71) Applicant: CANON KABUSHIKI KAISHA, Tokyo (JP)

(72) Inventors: SHINYA KITAGO, Chiba (JP); HIROYUKI TAKAHASHI, Chiba (JP)

(21) Appl. No.: 19/174,412

(22) Filed: Apr. 9, 2025

(30) Foreign Application Priority Data
Apr. 15, 2024 (JP) 2024-065812
Jan. 22, 2025 (JP) 2025-008823

(51) Int. Cl. H04N 1/00

(52) U.S. Cl. CPC H04N 1/00344; H04N 1/00538; H04N 1/00615; H04N 2201/0094

(57) ABSTRACT

An exterior cover is pivotably coupled with a main body frame by an upper hinge. The upper hinge includes a shaft member, a first shaft supporting member fixed to the back side of a frame of the exterior cover, a second shaft supporting member fixed to the main body frame, and a restriction member. Coupling the first shaft supporting member and the second shaft supporting member with each other enables holding the exterior cover in a state of being temporarily stationary relative to the main body frame. When the exterior cover is in a free state, the shaft member, the first shaft supporting member, and the second shaft supporting member are exposed upward. Since the restriction member is attached from above, it is possible to, while maintaining the exterior cover in the free state, attach the restriction member to the first shaft supporting member and the second shaft supporting member.

### BACKGROUND

### Field of the Disclosure

Aspects of the present disclosure generally relate to an image forming apparatus, such as a printing machine, a copying machine, or a printer, which performs image formation.

### Description of the Related Art

With regard to image forming apparatuses for use in industrial printing, the operator can visually check the operating status of an image forming apparatus. In the field of large-format inkjet printing machines, an image forming apparatus configured in such a manner that the behavior in which ink discharge heads are moving for scanning is viewable is provided. Moreover, in the field of label printing machines, an image forming apparatus similarly configured in such a manner that such an operating status is viewable is also on the market.

With regard to these image forming apparatuses, it is common that the height of the apparatus main body is less than a natural person's height. Examples of the configuration which allows visually checking the operating status include a configuration in which a recording unit of the image forming apparatus is not covered with an exterior cover. Japanese Patent Application Laid-Open No. 2016-215522 discusses a configuration in which an exterior cover is provided at the foreside of the image forming apparatus and a transparent window is arranged in a part of the exterior cover. Moreover, in such a configuration, an illumination lamp is provided inside the image forming apparatus to improve visibility.

In the field of commercial printing machines using cut sheets or fed sheets, a printing machine in which a recording unit is viewable is also on the market. In these printing machines, it is common that the apparatus size thereof is relatively larger than that of a large-format inkjet printing machine or a label printing machine, the height thereof is also around 2 meters (m), and a door serving as the exterior cover is a horizontally pivoting door (or horizontally pivoting and oppositely opening double doors).

### SUMMARY

According to an aspect of the present disclosure, an image forming apparatus includes an image forming unit configured to form an image on a sheet, a conveyance unit configured to convey a sheet in a first direction which intersects with a vertical direction, a main body frame configured to support the image forming unit and the conveyance unit, an exterior cover arranged on a front side of the image forming unit with respect to a front-back direction which intersects with the vertical direction and the first direction, the exterior cover forming at least a part of a front exterior of the image forming apparatus, and a hinge configured to couple the exterior cover and the main body frame. The hinge includes a first shaft supporting member attached to the main body frame, a second shaft supporting member attached to the exterior cover, a shaft member supported by the first shaft supporting member and the second shaft supporting member, and a restriction member configured to restrict a position of the shaft member. The exterior cover is configured to open and close by pivoting around the shaft member. The restriction member is configured to be attached to or detached from the first shaft supporting member and the second shaft supporting member in a state where the exterior cover is in a free state.

Further features of the present disclosure will become apparent from the following description of exemplary embodiments with reference to the attached drawings.

### BRIEF DESCRIPTION OF THE DRAWINGS

FIG. 1 is a schematic sectional view illustrating an outline configuration of an image forming apparatus.

FIG. 2 is a schematic sectional view of a print module.

FIG. 3 is a schematic diagram of the print module with a front door thereof opened as viewed from the front side thereof.

FIG. 4 is a perspective view of a print belt unit.

FIG. 5 is a perspective view of a recording head as viewed from an ink discharge surface direction.

FIG. 6 is a perspective view illustrating a withdrawal position of the recording head.

FIG. 7 is a perspective view illustrating a printing position of the recording head.

FIGS. 8A and 8B are diagrams used to explain the movement of the recording head to the printing position.

FIGS. 9A and 9B are diagrams used to explain the movement of the recording head to the printing position.

FIGS. 10A and 10B are diagrams used to explain the movement of the recording head to the printing position.

FIG. 11 is a perspective view illustrating a state occurring before the recording head is attached to a head holder.

FIGS. 12A and 12B are perspective views illustrating a movement operation of a scanner unit.

FIGS. 13A and 13B are perspective views illustrating the movement operation of the scanner unit.

FIG. 14 is a schematic perspective view illustrating a state in which a recording unit and a maintenance unit have been mounted on a main body frame of the print module.

FIG. 15 is a schematic diagram of the main body frame of the print module as viewed from directly above.

FIG. 16 is a left-side sectional view of the print module.

FIG. 17 is a sectional view of the print module taken along line G-G in FIG. 16.

FIGS. 18A and 18B are overall schematic diagrams of the front door of the print module.

FIG. 19 is a configuration exploded view of the front door of the print module.

FIGS. 20A and 20B are diagrams illustrating a state in which the front door of the print module is upward opened.

FIG. 21 is a diagram used to explain a hanging string of the front door which is upward opened.

FIG. 22 is a perspective view illustrating an upper hinge.

FIG. 23 is a perspective view illustrating the front door and the upper hinge.

FIG. 24 is a perspective view illustrating the main body frame and the upper hinge.

FIG. 25 is a perspective view illustrating the upper hinge.

FIGS. 26A and 26B are a perspective view and a front view, respectively, illustrating the upper hinge.

FIG. 27 is a perspective view illustrating the upper hinge.

FIG. 28 is a perspective view illustrating the front door and the main body frame of the print module and the upper hinge.

FIG. 29 is a perspective view illustrating an example of a lateral hinge door.

FIG. 30 is a perspective view illustrating a lateral hinge.

FIG. 31 is a perspective view illustrating the front door and the lateral hinge.

FIG. 32 is a perspective view illustrating the main body frame and the lateral hinge.

FIG. 33 is a perspective view illustrating the lateral hinge.

FIG. 34 is a perspective view illustrating the lateral hinge.

FIG. 35 is a perspective view illustrating the lateral hinge.

FIG. 36 is a perspective view illustrating the front door and the main body frame of the print module and the lateral hinge.

FIG. 37 is a perspective view illustrating the front door and the main body frame of the print module and the lateral hinge.

### DESCRIPTION OF THE EMBODIMENTS

The door for an exterior cover tends to become larger with the increase of the size of an apparatus. However, since a large-size door is heavy, it is often difficult to perform an operation for attaching the door. Therefore, it is desirable to facilitate an assembly operation. According to some exemplary embodiments of the present disclosure, an image forming apparatus capable of being easily assembled is provided.

Various exemplary embodiments, features, and aspects of an image forming apparatus according to the present disclosure will be described in detail below with reference to the drawings. Furthermore, with regard to, for example, the dimensions, materials, shapes, and relative locations of respective constituent components of an image forming apparatus to be described below, unless specifically described, the scope of the present disclosure is not limited only to those. Moreover, components assigned the respective same reference characters in the figures are the ones having the respective same configurations and functions, and any duplicated description thereof is omitted as appropriate.

### <Image Forming Apparatus>

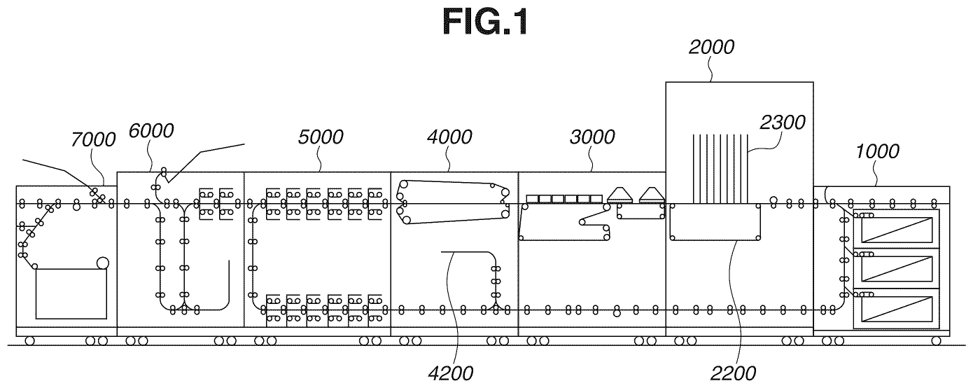

An outline configuration of an image forming apparatus according to a first exemplary embodiment is described with reference to FIG. 1. FIG. 1 is an outline diagram illustrating a configuration of the image forming apparatus. The image forming apparatus illustrated in FIG. 1 is an example of an inkjet image forming apparatus which performs image formation using an inkjet method.

The image forming apparatus performs processing on a sheet of paper (a recording medium) fed from a paper feed module 1000 while causing the sheet of paper to pass through a print module 2000, a drying module 3000, a fixing module 4000, a cooling module 5000, an inversion module 6000, and a paper ejection stacking module 7000 in this order. With regard to a sheet of paper fed from the paper feed module 1000, an image is then formed on the sheet by the print module 2000. The drying module 3000 is a unit which reduces a liquid content included in ink to increase the fixability between a sheet of paper and ink, and the sheet is then heated by the fixing module 4000 to soften ink adhering to the sheet. The sheet subjected to fixing is then cooled by the cooling module 5000 to solidify the softened ink, so that any change in temperature of the sheet at the downstream side of the cooling module 5000 is prevented or reduced. The orientation of the sheet is then adjusted to a desired orientation by the inversion module 6000. The sheets with printing thereon completed are aligned and stacked in the paper ejection stacking module 7000.

At the time of double-sided printing, the sheet is U-turned and conveyed toward the print module 2000 by the cooling module 5000, and, then, the front and back sides and the front-back direction of the sheet are switched around by an inversion device 4200 provided in the fixing module 4000. After that, the sheet passes through the duplexing conveyance paths of the drying module 3000, the print module 2000, and the paper feed module 1000 and is then conveyed to the print module 2000 again, so that back side printing is performed on the sheet.

In this way, the image forming apparatus includes the print module 2000 serving as a first module which includes a recording unit 2300 and a print belt unit 2200. Additionally, the image forming apparatus further includes modules (1000, 3000, 4000, 5000, 6000, and 7000) which have functions different from that of the print module 2000 and are coupled to one or both of the left side and right side in the right-left direction of the print module 2000. The right-left direction in the first exemplary embodiment are the conveyance direction of a sheet in performing image formation. The conveyance direction of a sheet may be referred to as a “first direction”. Thus, in the first exemplary embodiment, the first direction is the right-left direction. Moreover, in the first exemplary embodiment, the right side in the right-left direction corresponds to the upstream side, and the left side in the right-left direction corresponds to the downstream side.

While, here, a configuration in which the image forming apparatus includes modules which have respective modules different from that of the print module 2000 and are coupled at both sides in the right-left direction of the print module 2000 has been described as an example, the first exemplary embodiment is not limited to this configuration. A configuration in which the image forming apparatus includes modules which have respective modules different from that of the print module 2000 and are coupled at the left side in the right-left direction of the print module 2000 can be employed. Alternatively, a configuration in which the image forming apparatus includes modules which have respective modules different from that of the print module 2000 and are coupled at the right side in the right-left direction of the print module 2000 can also be employed.

### <Print Module>

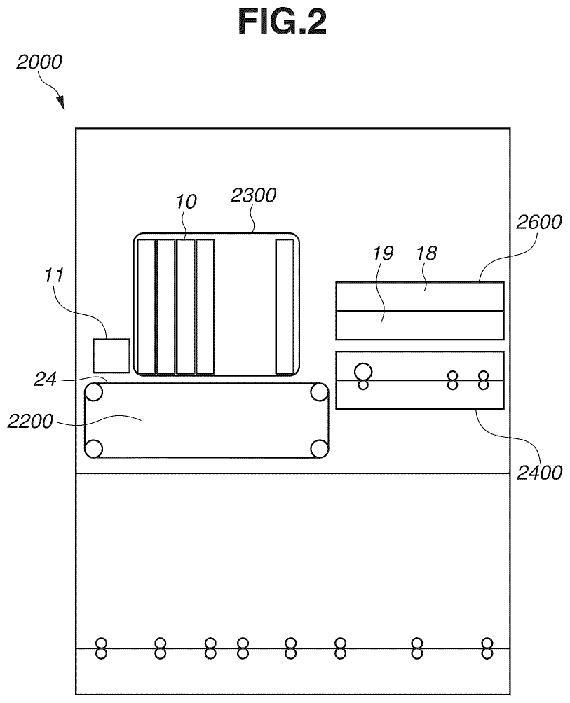

A configuration of the print module 2000 is described with reference to FIG. 2. FIG. 2 is a sectional schematic view of the print module 2000.

The print module 2000 is an image forming unit which, with regard to a sheet of paper to be conveyed (a recording medium), performs recording processing on the sheet of paper by recording heads 10 from above to form an image on the sheet of paper. The print module 2000 includes a pre-imaging registration correction unit 2400, the print belt unit 2200 serving as a conveyance unit, the recording unit 2300, a maintenance unit 2600, and a scanner unit 11. The sheet of paper is attracted by suction to and conveyed by the print belt unit 2200, so that the clearance from the recording heads 10 is ensured.

The sheet of paper conveyed from the paper feed module 1000 is conveyed to the print belt unit 2200 after the inclination or position of the sheet of paper is corrected by the pre-imaging registration correction unit 2400. With respect to a conveyance path for the sheet of paper, the recording unit 2300 is arranged at the position facing the print belt unit 2200. The recording unit 2300 performs recording processing (printing) on a sheet of paper, which is being conveyed, by the recording heads 10 from above to form an image on the sheet of paper. With regard to conveyance of a sheet of paper in the recording unit 2300, to stabilize a sheet conveyance behavior immediately beneath the recording heads 10, the print belt unit 2200, which conveys the sheet of paper while attracting the sheet of paper by suction, is arranged. The sheet of paper, which is conveyed on a sheet conveyance surface 24 in the print belt unit 2200, is conveyed in a state in which the clearance from the recording heads 10 has been ensured. The recording heads 10 discharge ink to the sheet of paper, which is being conveyed, while adjusting discharge timing to perform image formation. The recording unit 2300 includes a plurality of recording heads 10 arranged side by side along the conveyance direction. In the first exemplary embodiment, the recording unit 2300 includes a total of five line-type recording heads 10 corresponding to four colors, i.e., yellow (Y), magenta (M), cyan (C), and black (Bk), and a reaction liquid.

The scanner unit 11 is placed at the downstream side in the conveyance direction of the recording heads 10. The scanner unit 11 reads the paper and an image formed thereon on the sheet conveyance surface 24 of the print belt unit 2200 to inspect an image formed immediately after ink application. When having detected an image defect such as an ink undischarged state caused by clogging of ink discharge ports, the scanner unit 11 immediately stops the image forming apparatus, thus preventing or reducing generation of a faulty print product to the minimum. The scanner unit 11 is a unit (recording unit) which not only detects the discharging state of ink but also reads an image formed on a sheet of paper by the recording unit 2300 during printing and detects any misalignment or density deficit of the image to cause printing to be corrected.

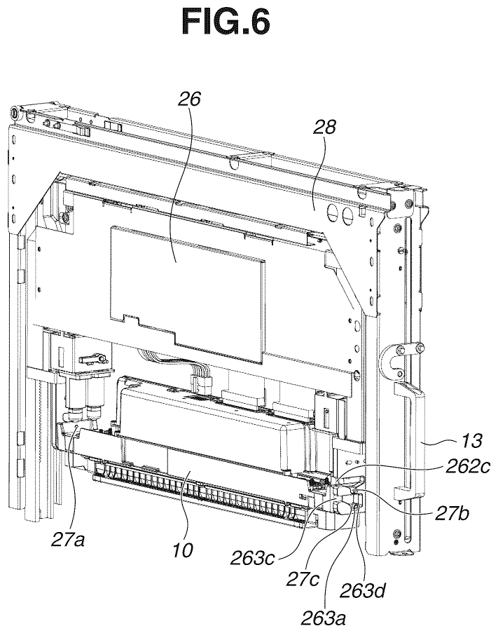

The maintenance unit 2600 is arranged on the right side of the recording unit 2300. The recording head 10 of the recording unit 2300 is able to move upward and move downward and, as needed, can move to a withdrawal position (see FIG. 6) at the vertically upper position. The maintenance unit 2600 moves to immediately below the recording head 10 moved to the withdrawal position and then performs maintenance of the recording unit 2300 (recording heads 10).

The maintenance unit 2600 includes a cap tray 18, in which a cap mechanism (not illustrated) for protecting the ink discharge surface of the recording head 10 is arranged. The maintenance unit 2600 further includes a cleaning tray 19, in which a cleaning mechanism (not illustrated) for recovering the ink discharge performance of the recording head 10 is arranged. The maintenance unit 2600 is formed as a two-layered unit including the cap tray 18 at the upper stage and the cleaning tray 19 at the lower stage. Furthermore, the ink discharge surface is a discharge port surface (nozzle surface) on which a plurality of discharge ports for discharging ink are arrayed in the recording head 10.

During non-operation of the image forming apparatus, the cap tray 18 is immediately below the recording unit 2300 and the recording heads 10 land on the cap mechanism (not illustrated) of the cap tray 18, so that capping is performed to prevent drying of the ink discharge surfaces of the recording heads 10. In response to a print start instruction issued by a controller (not illustrated), first, the recording heads 10 move upward to the withdrawal position thereof to move away from the cap tray 18, next, the cap tray 18 withdraws to the withdrawal position thereof, and, after that, the recording heads 10 move downward to the printing position, thus performing a printing operation. In response to a print end instruction, the recording heads 10 move upward to the withdrawal position thereof. After that, the cap tray 18 moves from the withdrawal position thereof to immediately below the recording unit 2300 and, then, the recording heads 10 move downward and lands on the cap tray 18, so that capping is performed to lead to a stopped state.

Even during printing, when a predetermined continuous operating time has been reached, a cleaning instruction is issued by the controller (not illustrated). In response to the cleaning instruction, after the recording heads 10 move upward to the withdrawal position thereof, the lower-stage cleaning tray 19 of the maintenance unit 2600 moves to immediately below the recording unit 2300. After that, the recording heads 10 move downward and land on the cleaning tray 19, so that a cleaning operation such as wiping or vacuum cleaning is performed. After the completion of cleaning, the recording heads 10 move upward to the withdrawal position thereof, the cleaning tray 19 moves from immediately below the recording unit 2300 to the withdrawal position thereof, and, then, the recording heads 10 move downward to the printing position, thus resuming printing. In the case of not resuming printing after the completion of cleaning, the recording heads 10 move upward to the withdrawal position thereof, the cleaning tray 19 moves from immediately below the recording unit 2300 to the withdrawal position thereof, and the cap tray 18 moves from the withdrawal position thereof to immediately below the recording unit 2300. Then, the recording heads 10 move downward and land on the cap tray 18, so that capping is performed to lead to a stopped state. Cleaning of the recording heads 10 during a printing operation in progress can be performed after sheets of paper circulating in the image forming apparatus are completely subjected to print processing and supplying of new sheets of paper is stopped. Alternatively, cleaning of the recording heads 10 during a printing operation in progress can be performed when sheets of paper circulating in the image forming apparatus have been temporarily stopped in a given condition.

Furthermore, the number of ink colors and the number of recording heads in the image forming apparatus are not limited to five. Moreover, examples of the inkjet method to be employed include a method using heater elements, a method using piezoelectric elements, a method using electrostatic elements, and a method using micro-electromechanical system (MEMS) elements.

### <Configuration of Recording Unit>

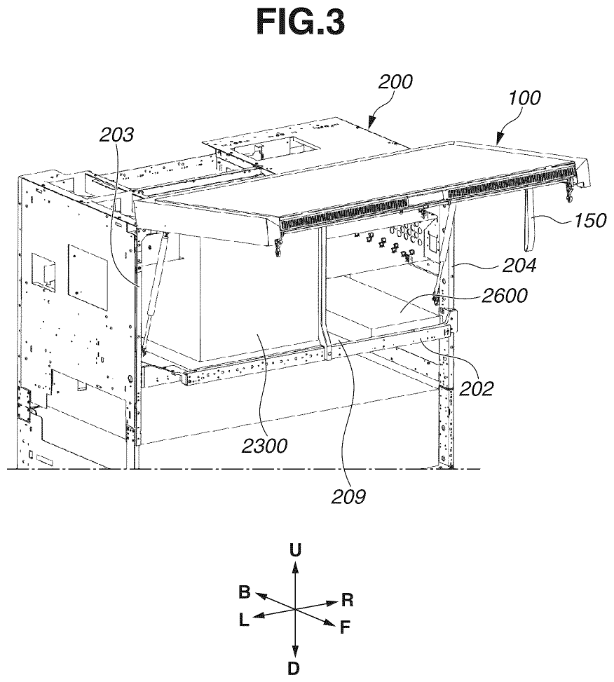

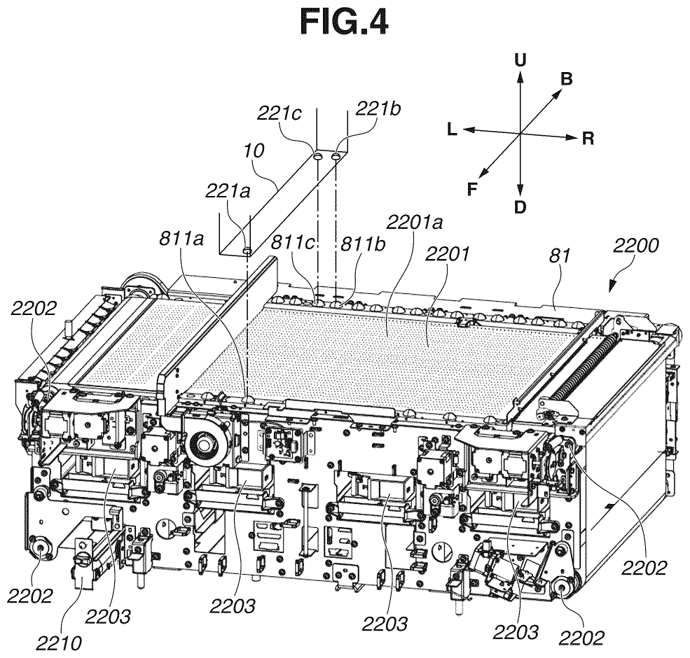

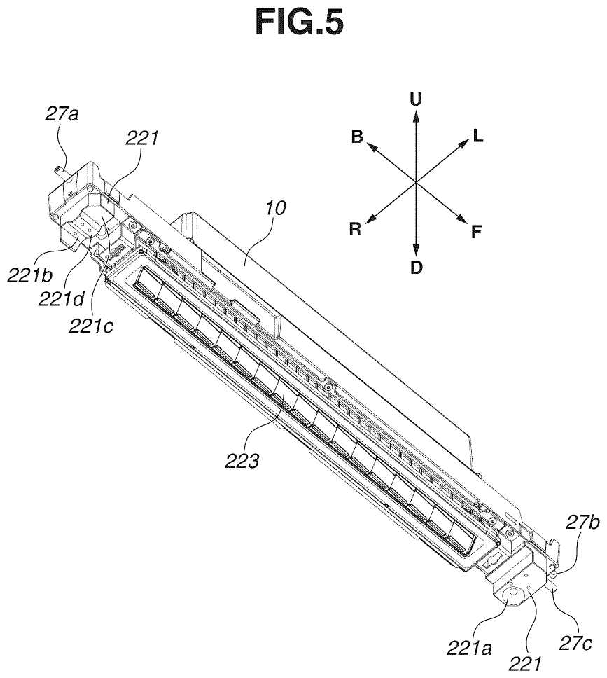

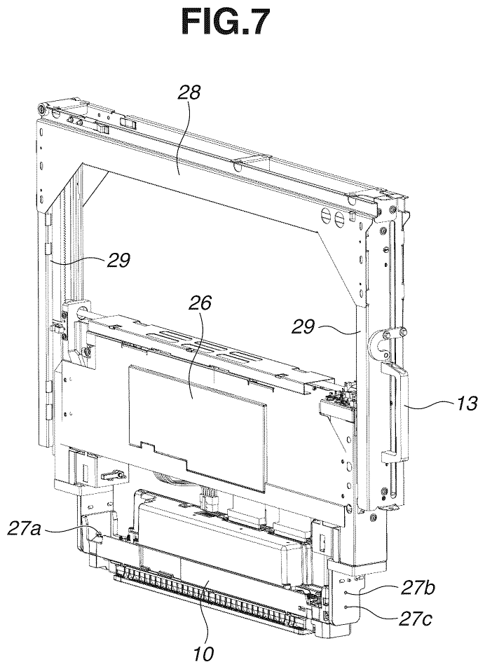

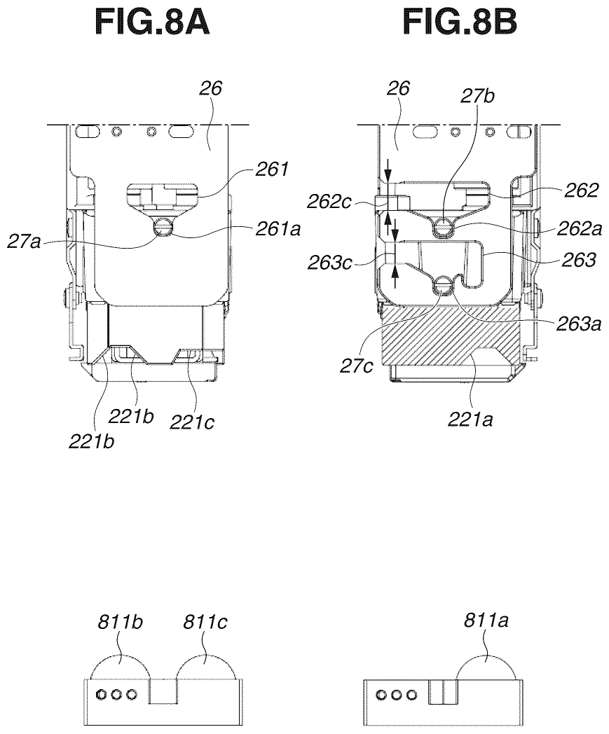

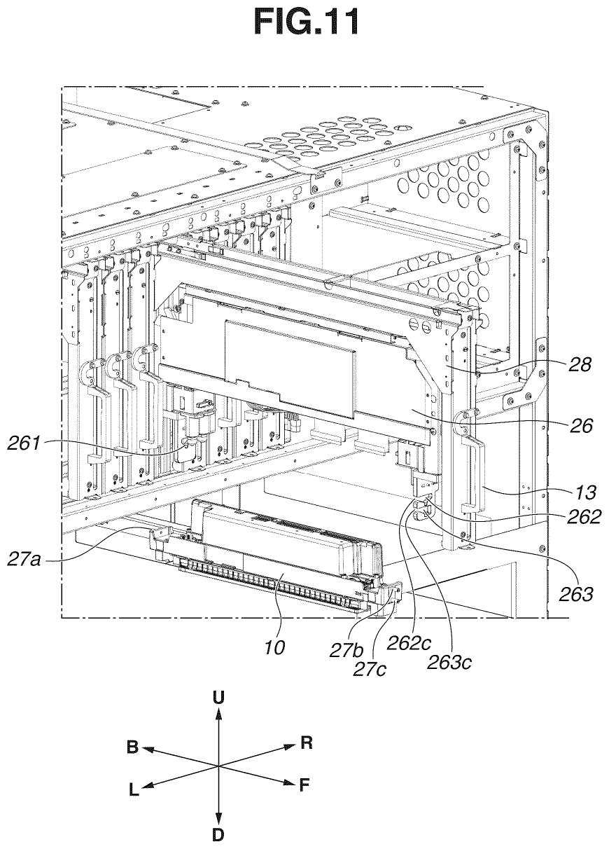

Next, configurations of the recording unit 2300 and the print belt unit 2200 in the first exemplary embodiment are described with reference to FIG. 3 to FIG. 11. FIG. 3 is a schematic diagram of the print module 2000 with a front door (exterior cover) thereof, which covers the recording unit 2300, opened as viewed from the front side thereof. FIG. 4 is a perspective view of the print belt unit 2200. FIG. 5 is a perspective view of the recording head 10 as viewed from the ink discharge surface direction. FIG. 6 is a perspective view illustrating a state in which the recording head 10 is in the withdrawal position, and FIG. 7 is a perspective view illustrating a state in which the recording head 10 is in the printing position. FIGS. 8A and 8B to FIGS. 10A and 10B are diagrams used to explain the movement of the recording head 10 to the printing position. FIG. 11 is a perspective view illustrating a state occurring before the recording head 10 is attached to a head holder 26.

In the following description, upward direction U, downward direction D, rightward direction R, leftward direction L, backward direction B, and frontward direction F are defined as illustrated in FIG. 3. The side on which a front door 100 serving as an exterior cover is arranged relative to a main body frame 200 (print module 2000) illustrated in FIG. 3 is defined as a front side (a near side or a frontal side), and the side opposite to the front side is defined as a back side (a far side or a rear side). Moreover, the side on which the scanner unit 11 (see FIG. 2) is arranged as viewed based on the recording unit 2300 is defined as a left side. The side on which the maintenance unit 2600 is arranged as viewed based on the recording unit 2300 is defined as a right side. Additionally, a direction which is perpendicular to the front-back direction and right-left direction defined here and is upward in the vertical direction is defined as an upward direction, and, moreover, a direction which is perpendicular to the front-back direction and right-left direction defined here and is downward in the vertical direction is defined as a downward direction. The thus-defined frontward direction F, backward direction B, rightward direction R, leftward direction L, upward direction U, and downward direction D are illustrated in FIG. 3. The right-left direction are directions perpendicular to the vertical direction (upward and downward directions) and are the same as the conveyance directions in which to convey a sheet of paper. The front-back direction are directions perpendicular to the vertical direction and the right-left direction (first direction).

As illustrated in FIG. 4, the print belt unit 2200 includes, for example, a print belt 2201, belt rollers 2202, suction units 2203, and a cleaning unit 2210. The print belt 2201 serves as a contact surface which has contact with a sheet of paper during conveyance of the sheet of paper, and is provided with a plurality of suction holes 2201a in the right-left direction and front-back direction. The suction holes 2201a are through-holes each penetrating in the depth direction of the print belt 2201, and are provided while being distributed to the inside and outside of a region through which a sheet of paper passes during conveyance of the sheet of paper. The belt rollers 2202 keep the tension of the print belt 2201 constant. The suction units 2203 perform attraction by suction of a sheet of paper via the suction holes 2201a. The cleaning unit 2210 comes into abutting contact with the print belt 2201 to wipe out mist or paper dust adhering to the surface of the print belt 2201. While, in the first exemplary embodiment, four suction units 2203 are arranged in the print belt unit 2200, the number of suction units 2203 is not limited to four.

The print belt unit 2200 is arranged immediately below the recording heads 10. Thus, the print belt unit 2200 is arranged at a position facing the recording unit 2300 in the vertical direction. The print belt unit 2200 has a height adjustment function of adjusting the height of a paper conveyance surface (sheet conveyance surface) in such a manner that a predetermined clearance is ensured between the surface of a sheet of paper and the recording heads 10 in conformity with the thickness of the sheet of paper. The print belt unit 2200 has, as mentioned above, a suction conveyance function of conveying a sheet of paper while keeping the sheet of paper plane following the surface of the print belt 2201.

A casing 81 of the print belt unit 2200 is provided with a positioning member 811 for performing positioning of the recording head 10 at the printing position (recording position). Specifically, with respect to each recording head 10, across the print belt 2201, one positioning member 811a is provided at the near side (frontal side of the image forming apparatus) in the front-back direction (sheet width direction) and two positioning members 811b and 811c are provided at the far side (rear side of the image forming apparatus).

As illustrated in FIG. 5, the recording head 10 includes a nozzle plate 223, which includes a plurality of nozzles for discharging ink, arranged in order in the recording head longitudinal direction (sheet width direction or front-back direction), and abutting contact portions 221 are provided at both ends of the recording head 10. Specifically, a first abutting contact portion 221a, which is composed of a recessed portion having a cone-shaped slant surface, is provided at the near side in the longitudinal direction of the recording head 10, and a second abutting contact portion 221b, which is composed of a groove portion having two V-shaped flat surfaces, and a third abutting contact portion 221c, which is composed of a flat surface portion, are provided at the far side in the longitudinal direction of the recording head 10. Here, in the vicinity of the third abutting contact portion 221c, which is composed of a flat surface portion, a guide shape 221d is provided to play the role of resolving an issue in which, when the third abutting contact portion 221c and the recording head positioning member 811c come into abutting contact with each other, the recording head (ink discharge head) 10 slides to cause misregistration so that it is impossible to perform positioning due to a ball not entering into a positioning portion.

FIG. 6 is a schematic perspective view illustrating a state in which the recording head 10 is in a withdrawal position where the recording head 10 has withdrawn upward relative to the print belt unit 2200. FIG. 7 is a schematic perspective view illustrating a state in which the recording head 10 is in a printing position (recording position) where the recording head 10 records an image on a sheet of paper. The recording head 10 is attached to the head holder 26 in such a way as to be attachable to and detachable from the head holder 26. The recording head 10 is automatically raised and lowered in the vertical direction integrally with the head holder 26 by a driving mechanism (not illustrated) between the printing position, in which the recording head 10 lies close to the sheet conveyance surface 24, and the withdrawal position, in which the recording head 10 is when not performing printing, along raising and lowering rails 29 provided in a recording head raising and lowering frame 28.

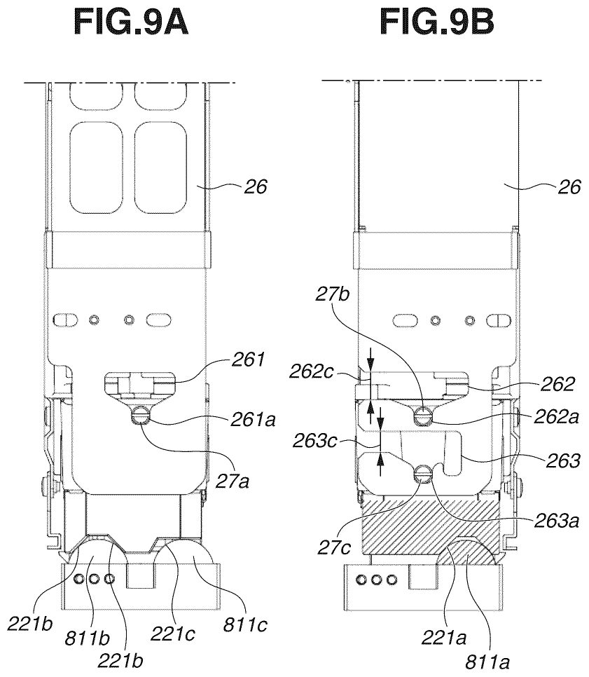

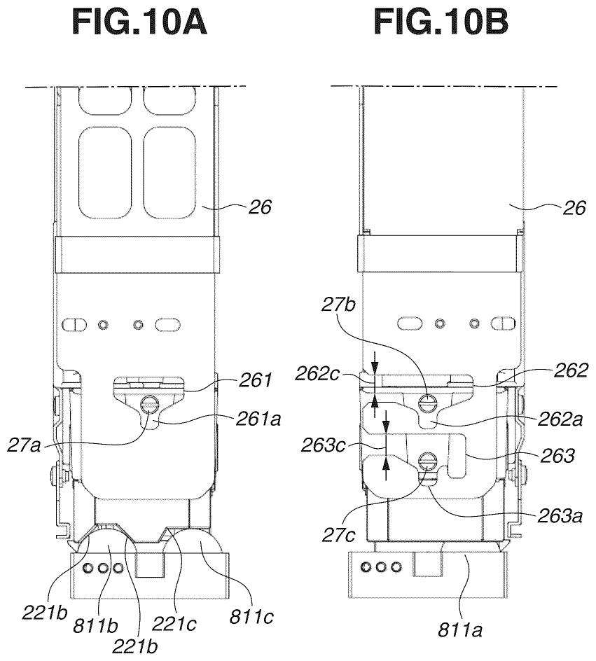

The behavior in which the recording head 10 moves from the withdrawal position to the printing position and then engages with the positioning member 811 is described with reference to FIGS. 8A and 8B, FIGS. 9A and 9B, and FIGS. 10A and 10B. FIGS. 8A, 9A, and 10A are diagrams of the recording head 10 as viewed from the back side in the front-back direction. FIGS. 8B, 9B, and 10B are diagrams of the recording head 10 as viewed from the front side in the front-back direction. The recording head 10 being in the withdrawal position as illustrated in FIGS. 8A and 8B is lowered integrally with the head holder 26 and lands on the positioning members 811a to 811c of the print belt unit 2200 as illustrated in FIGS. 9A and 9B. After that, the head holder 26 is further lowered and the self-weight of the recording head 10 is put on the positioning members 811a to 811c, so that the spherical shapes of the positioning members 811a to 811c strongly engage with the conical recess shapes of the abutting contact portions 221a to 221c of the recording head 10 as illustrated in FIGS. 10A and 10B. This enables performing accurate positioning of the recording head 10 and the print belt unit 2200. The abutting contact of the recording head 10 with the positioning members 811a to 811c can be caused by only the self-weight of the recording head 10 or by the application of an abutting contact force by another pressure unit (not illustrated).

Next, an attaching operation which is performed to set the recording head 10 to the print module 2000 is described with reference to FIG. 11. FIG. 11 is a perspective view illustrating a state occurring before the recording head 10 is attached to the print module 2000.

As illustrated in FIG. 11, to set the recording head 10 to the print module 2000, first, the operator performs the attaching operation in a state in which the recording head raising and lowering frame 28 has been pulled out from the print module 2000 to the near side in the front-back direction. The recording unit 2300 is provided with a handle 13 at the front end in the front-back direction of the recording head raising and lowering frame 28. The operator grips the handle 13 and pulls out the recording head raising and lowering frame 28 from the print module 2000 to the near side in the front-back direction. Then, the operator goes around to the left side of the recording head raising and lowering frame 28 which has been pulled out, directly faces the left surface of the head holder 26, and then performs mounting of the recording head 10 to the head holder 26. The recording head 10 is then held by the head holder 26, which has the automatic raising and lowering function as mentioned above, and is thus coupled to the head holder 26 by, for example, pins described below.

To attach the recording head 10 to the head holder 26, first, the operator inserts a first pin 27a, which is provided at the far side of the recording head 10, into a first hole 261 of the head holder 26. After that, the operator leads a second pin 27b, which is provided at the near side of the recording head 10, from a second cutout portion 262c of the head holder 26 into a second hole 262, and also leads a third pin 27c from a third cutout portion 263c into a third hole 263. Additionally, the operator causes the first pin 27a, the second pin 27b, and the third pin 27c to be supported by a first groove portion 261a of the first hole 261, a second groove portion 262a of the second hole 262, and a third groove portion 263a of the third hole 263, respectively. This enables the operator to attach the recording head 10 to the head holder 26 in a state in which the orientation of the recording head 10 relative to the head holder 26 has been determined. At that time, as illustrated in FIG. 11, the first pin 27a and the first hole 261 are arranged at the far side in the sheet width direction, and the second pin 27b, the third pin 27c, the second hole 262, and the third hole 263 are arranged at the near side in the sheet width direction. Therefore, the operator only needs to insert the first pin 27a into the first hole 261 at the far side, which is away from the operator's hand, and performs an operation for leading the second pin 27b and the third pin 27c into the second hole 262 and the third hole 263, respectively, at the near side, which is close to the operator's hand. This enables the operator to easily set the recording head 10 to the head holder 26.

Furthermore, as mentioned above, the print belt unit 2200 includes the print belt 2201 serving as a conveyance belt which conveys a sheet of paper while attracting the sheet of paper by suction. The print belt 2201 has a color (dark color) large in contrast ratio with that of a sheet of paper.

### <Configuration of Reading Unit>

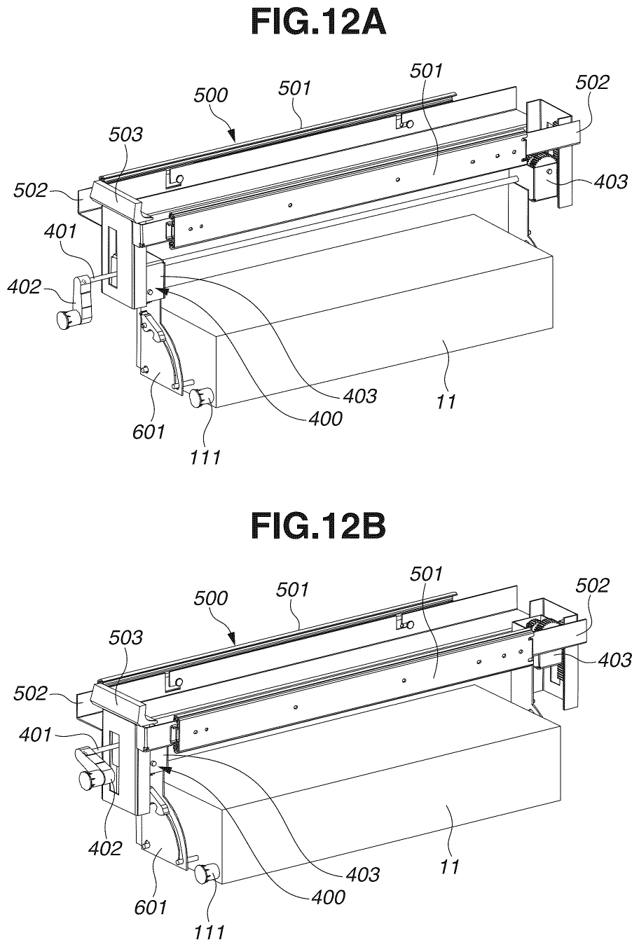

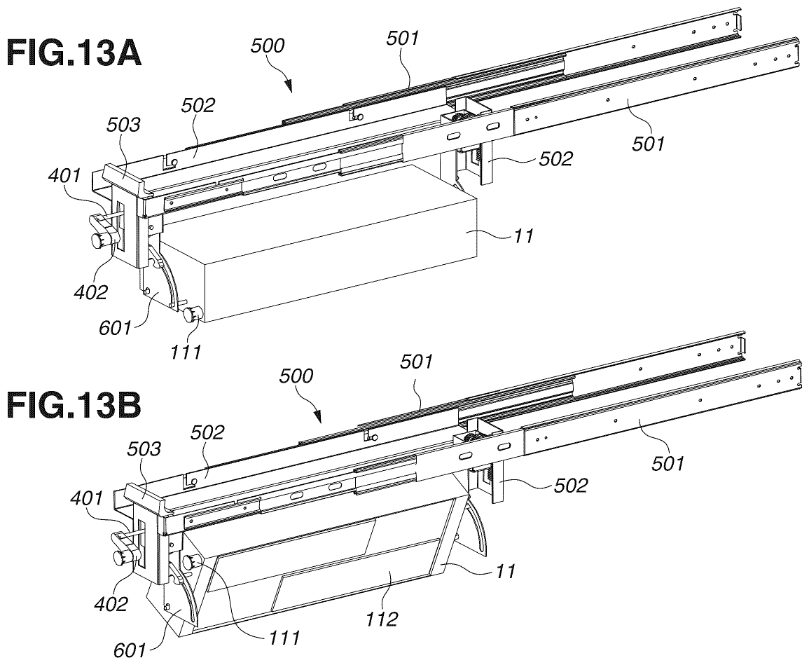

Next, a configuration of the scanner unit 11, which serves as a reading unit, is described with reference to FIGS. 12A and 12B and FIGS. 13A and 13B. FIGS. 12A and 12B and FIGS. 13A and 13B are perspective views illustrating an up-and-down operation and a turning operation serving as moving operations of the scanner unit 11.

The scanner unit 11 is provided in such a way as to be movable between a reading position, in which the scanner unit 11 is able to read an image of the sheet of paper, and a separation position, which is more separate from the print belt 2201 than the reading position. FIG. 12A illustrates a case where the scanner unit 11 is in the reading position, and FIG. 12B illustrates a case where the scanner unit 11 is in the separation position. As illustrated in FIGS. 12A and 12B, the scanner unit 11 is caused by a raising and lowering unit 400 to move between the reading position and the separation position in the vertical direction while keeping a state in which a reading surface 112 faces downward in the vertical direction and thus faces the print belt 2201. In the case of the first exemplary embodiment, when the scanner unit 11 is in the reading position and in the separation position, the reading surface 112 is in a facing position, in which the reading surface 112 faces the print belt 2201.

The raising and lowering unit 400 is described with reference to FIGS. 12A and 12B. As illustrated in FIGS. 12A and 12B, the raising and lowering unit 400 includes a rotational shaft 401, a handle 402, and a pair of raising and lowering portions 403. The rotational shaft 401 is provided to extend in the front-back direction (sheet width direction) perpendicular to the conveyance direction, in which a sheet of paper is conveyed, and the vertical direction. The handle 402 is fixed to one end portion in the sheet width direction of the rotational shaft 401 in such a way as to enable the user (operator) to grip the handle 402 and rotate the rotational shaft 401.

The pair of raising and lowering portions 403 is placed opposite each other at both end portions in the sheet width direction of the rotational shaft 401 and pivotally supports the rotational shaft 401 in such a way as to make the rotational shaft 401 rotatable. The raising and lowering portions 403 raise and lower the scanner unit 11 in the vertical direction according to the rotation of the rotational shaft 401. However, each of the raising and lowering portions 403 is provided with a holding plate 601 on the lower side thereof in the vertical direction, and the holding plates 601 hold the scanner unit 11 in such a way as to make the scanner unit 11 freely turnable. In the first exemplary embodiment, in response to the user rotating the handle 402, the holding plates 601 are moved in the vertical direction together with the raising and lowering portions 403 and the rotational shaft 401, and, accordingly, the scanner unit 11, which is held by the holding plates 601, is raised or lowered.

According to the above-mentioned raising and lowering unit 400, the user is able to operate the handle 402 to raise or lower the scanner unit 11 in the vertical direction. In the first exemplary embodiment, in a case where the user wants to clean the reading surface 112 of the scanner unit 11, first, the user needs to move the scanner unit 11 from the reading position (see FIG. 12A) to the separation position (see FIG. 12B). In that case, the user grips the handle 402 and operates the handle 402 in such a way as to rotate the rotational shaft 401 clockwise. Then, as the raising and lowering portions 403 move upward in the vertical direction, the scanner unit 11, which is held by the holding plates 601, moves to the separation position. The separation position is a position which is more distant from the print belt 2201 than the reading position.

Moreover, the scanner unit 11 is provided in such a way as to be movable between a facing position, in which the reading surface 112 faces the print belt 2201, and a non-facing position (hereinafter referred to as a “pulled-out position”), in which the reading surface 112 does not face the print belt 2201, in the front-back direction in a state in which the scanner unit 11 is in the above-mentioned separation position (see FIG. 12B). FIG. 13A illustrates a case where the scanner unit 11 is in the pulled-out position. As illustrated in FIG. 13A, the scanner unit 11 is caused by a pull-out unit 500 to move in a sliding manner between the separation position (facing position) and the pulled-out position in the sheet width direction in a state in which the reading surface 112 faces downward in the vertical direction.

The pull-out unit 500 is described with reference to FIG. 12B and FIG. 13A. Furthermore, FIG. 12B illustrates a state in which the scanner unit 11 is in the separation position, i.e., a state occurring before the scanner unit 11 is pulled out to the pulled-out position. As illustrated in FIG. 12B, the pull-out unit 500 includes a pair of slide rails 501, which is provided to extend in the sheet width direction while being spaced in the conveyance direction, and a mobile frame 502, which holds the above-mentioned raising and lowering unit 400 and is provided in such a way as to be freely movable in a sliding manner along the slide rails 501 between the separation position and the pulled-out position. The slide rails 501 are fixed to the casing of the print module 2000. One end side in the sheet width direction of the mobile frame 502 is provided with a frame grip portion 503, which the user grips to move the mobile frame 502 in a sliding manner.

In a case where the user wants to clean the reading surface 112 of the scanner unit 11, the user needs to, after moving the scanner unit 11 from the reading position (see FIG. 12A) to the separation position (see FIG. 12B), move the scanner unit 11 from the separation position (facing position) to the pulled-out position (see FIG. 13A).

In that case, the user manually rotates the handle 402 to raise the scanner unit 11 from the reading position to the separation position (the position illustrated in FIG. 12B). After that, the user grips the frame grip portion 503 and then pulls the mobile frame 502 toward the near side. Then, the mobile frame 502 moves in a sliding manner to the pulled-out position along the slide rails 501. With this movement, the raising and lowering unit 400 also moves to the pulled-out position and, accordingly, the scanner unit 11, which is held by the holding plates 601, moves to the pulled-out position. In the case of the first exemplary embodiment, when the scanner unit 11 is in the pulled-out position, the scanner unit 11 is in a state of having been pulled out, from the inside of the casing of the print module 2000 to the outside of the casing, to the near side more than the casing, so that the reading surface 112 becomes exposed on the outside of the casing of the print module 2000.

After that, the user holds a rotational manipulation lever 111 and rotates the scanner unit 11 about 90 degrees (see FIG. 13B) in such a way as to facilitate a wiping-out operation, thus making the reading surface 112 visibly checkable, and performs cleaning. While, in the first exemplary embodiment, the raising and lowering function is performed by operating the handle 402, the raising and lowering operation of the scanner unit 11 can be manually performed or can be automatically performed with use of an electrically driven unit.

Furthermore, the scanner unit 11, which is arranged at the downstream side of the recording unit 2300, has a positioning configuration similar to that of the above-mentioned recording head 10 and has a difference from the recording head 10 as to whether the raising and lowering operation is automatically performed or manually performed. Since the raising and lowering operation of the scanner unit 11 is performed only at the time of cleaning of the reading surface 112, the frequency of the raising and lowering operation is small, and, therefore, the manual operation method is employed.

### <Configuration of Maintenance Unit>

A configuration of the maintenance unit 2600 is described with reference to FIG. 2.

As mentioned above, the maintenance unit 2600 includes the cap tray 18, in which a cap mechanism (not illustrated) is arranged, and the cleaning tray 19, in which a cleaning mechanism (not illustrated) is arranged. The cap tray 18 and the cleaning tray 19 are configured to be individually movable in the right-left direction of the print module 2000 along rails (not illustrated) provided in the print module 2000. The rails are a guide mechanism which guides the movement in the right-left direction while supporting the end portions in the sheet width direction (front-back direction) of the cap tray 18 and the cleaning tray 19.

At the time of a recording state for performing recording on a sheet of paper by the recording head 10, the cap tray 18 and the cleaning tray 19 are located at the upstream side (right side) in the sheet conveyance direction of the recording unit 2300. At the time of the recording state, the cap tray 18 is located immediately above the cleaning tray 19. The positions of the cap tray 18 and the cleaning tray 19 in the recording state are also referred to as a “standby position”.

At the time of a cap state in which the ink discharge surface of the recording head 10 is capped by the cap mechanism, the cap tray 18 is located immediately below the recording head 10 of the recording unit 2300, and the cleaning tray 19 is located on the upstream side in the sheet conveyance direction of the recording unit 2300. Thus, at the time of the cap state, the cap tray 18 is in a state of having moved from the standby position to the cap position at the downstream side in the sheet conveyance direction along the rails, and the cleaning tray 19 is in a state of being located in the standby position.

At the time of a cleaning state for cleaning the ink discharge surface of the recording head 10 by the cleaning mechanism, the cleaning tray 19 is located immediately below the recording head 10 of the recording unit 2300, and the cap tray 18 is located at the upstream side in the sheet conveyance direction of the recording unit 2300. Thus, at the time of the cleaning state, the cleaning tray 19 is in a state of having moved from the standby position to the cleaning position at the downstream side in the sheet conveyance direction along the rails, and the cap tray 18 is in a state of being located in the standby position.

Each cap mechanism included in the cap tray 18 includes a plurality of spherical positioning members (not illustrated) for positioning the recording head 10 relative to the cap mechanism. The positioning members are arranged at both ends of each cap mechanism in the sheet width direction (front-back direction). Thus, the positioning members are provided in a manner similar to that in the positioning members 811a to 811c in the print belt unit 2200. Causing the positioning members 211a to 211c of each recording head 10 to engage with the positioning members of each cap mechanism enables performing positioning of the recording head 10 and the cap mechanisms.

Moreover, as with the above-mentioned positioning members of the cap mechanism, the cleaning tray 19 includes a plurality of spherical positioning members (not illustrated) for positioning the recording head 10 relative to the cleaning tray 19. Thus, the positioning members are provided in a manner similar to that in the positioning members 811a to 811c in the print belt unit 2200. Causing the positioning members 211a to 211c of each recording head 10 to engage with the positioning members of the cleaning tray 19 enables performing positioning of the recording head 10 and the cleaning tray 19.

Furthermore, the cleaning tray 19 includes a movement mechanism (not illustrated) which moves a cleaning mechanism (not illustrated) for recovering the ink discharge performance of the recording head 10 along a wipe-off direction (front-back direction) perpendicular to the sheet conveyance direction. The cleaning mechanism recovers the ink discharge performance of the recording head 10 by performing removal of ink or dust adhering to the ink discharge surface of the recording head 10 while being moved in the wipe-off direction by the movement mechanism.

### <Configuration of Main Body Frame>

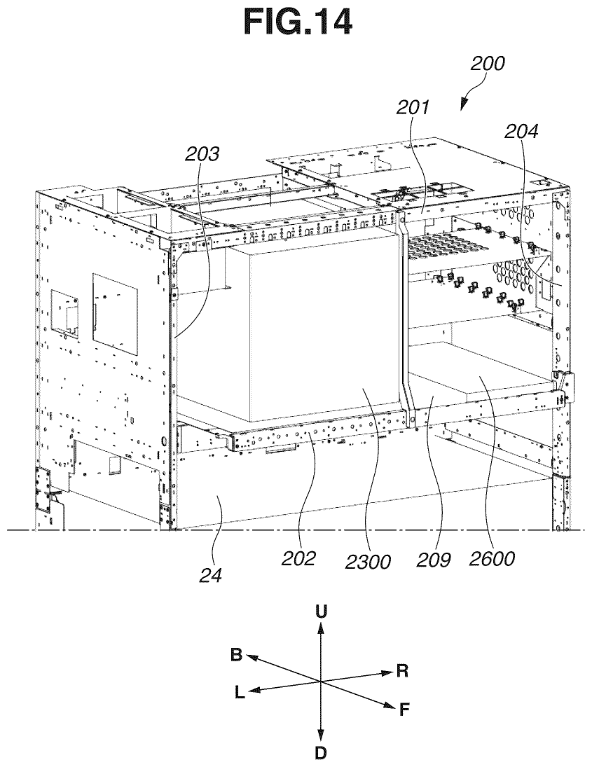

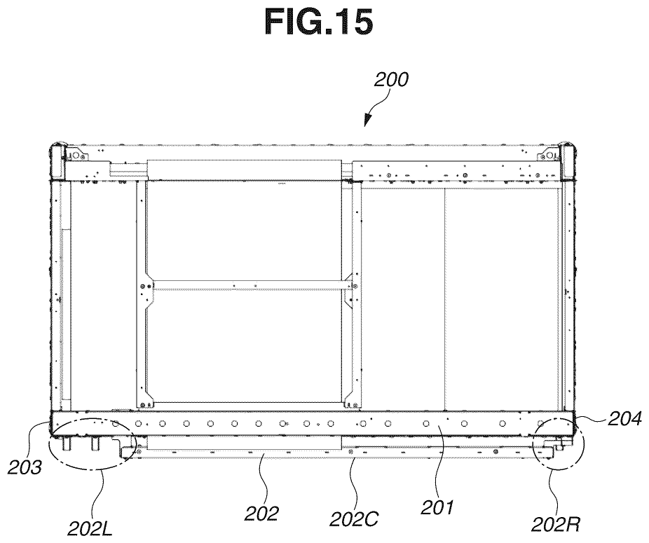

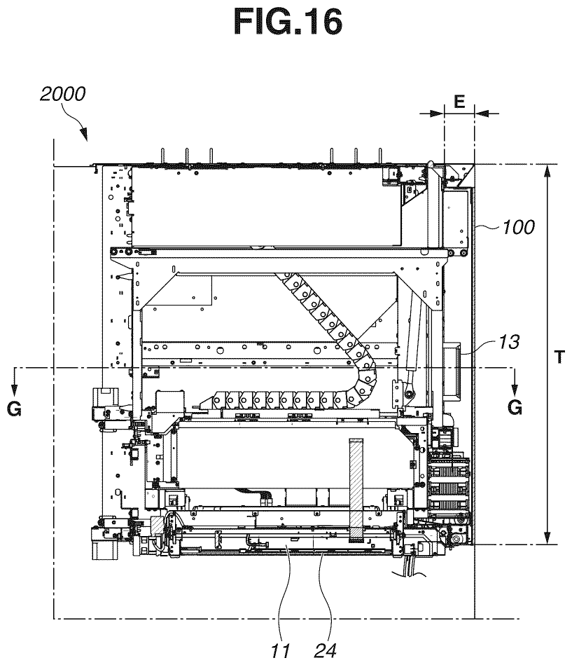

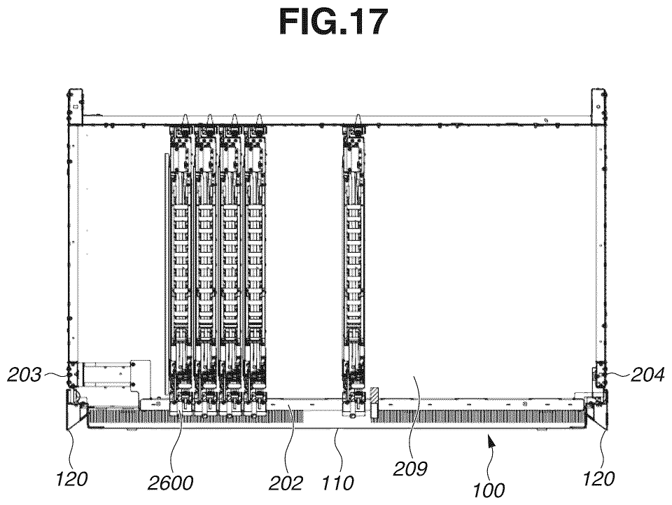

Next, the main body frame 200 of the print module 2000 is described with reference to FIG. 14, FIG. 15, FIG. 16, and FIG. 17. FIG. 14 is a schematic perspective view illustrating a state in which the recording unit 2300 and the maintenance unit 2600 have been mounted on the main body frame 200 of the print module 2000. FIG. 15 is a schematic diagram of the main body frame 200 of the print module 2000 as viewed from directly above. FIG. 16 is a left-side sectional view of the print module 2000. FIG. 17 is a sectional view of the print module 2000 taken along line G-G in FIG. 16.

The print module 2000 includes the main body frame 200, which supports the recording unit 2300 and the print belt unit 2200. The main body frame 200 includes, for example, an upper horizontal pillar 201, a middle horizontal pillar 202, a left support pillar 203, and a right support pillar 204.

The main body frame 200 includes the left support pillar 203 and the right support pillar 204, which are provided at both sides in the right-left direction. Each of the left support pillar 203 and the right support pillar 204 extends in the vertical direction. In other words, the left support pillar 203 and the right support pillar 204 are provided opposite each other in the right-left direction of the main body frame 200. The left support pillar 203 is arranged at the left front of the main body frame 200, and the right support pillar 204 is arranged at the right front of the main body frame 200.

The recording unit 2300, the scanner unit 11, and the maintenance unit 2600 are supported by the main body frame 200. The recording unit 2300, the scanner unit 11, and the maintenance unit 2600 are arranged between the left support pillar 203 and the right support pillar 204 of the main body frame 200. The scanner unit 11 is arranged at the left side of the recording unit 2300 between the left support pillar 203 and the right support pillar 204 of the main body frame 200. Thus, the scanner unit 11 is arranged between the left support pillar 203 and the recording unit 2300. The maintenance unit 2600 is arranged at the right side of the recording unit 2300 between the left support pillar 203 and the right support pillar 204 of the main body frame 200. Thus, the maintenance unit 2600 is arranged between the right support pillar 204 and the recording unit 2300.

In the main body frame 200, the upper horizontal pillar 201 is provided in such a way as to extend in the right-left direction between the left support pillar 203 and the right support pillar 204 of the main body frame 200. The upper horizontal pillar 201 is coupled to the upper end of the left support pillar 203 and the upper end of the right support pillar 204. The middle horizontal pillar 202 is provided in such a way as to extend in the right-left direction between the left support pillar 203 and the right support pillar 204 of the main body frame 200, and is located at a position lower than the upper horizontal pillar 201. The middle horizontal pillar 202 is coupled to the left support pillar 203 and the right support pillar 204. As illustrated in FIG. 14, the upper horizontal pillar 201 and the middle horizontal pillar 202 are arranged in such a way as to extend in the right-left direction.

The recording unit 2300, the scanner unit 11, and the maintenance unit 2600 are arranged at positions lower than the upper horizontal pillar 201 of the main body frame 200. With regard to a relative relationship with the middle horizontal pillar 202, the recording unit 2300 is arranged at a position upper than the middle horizontal pillar 202. In other words, the recording unit 2300 is arranged between the upper horizontal pillar 201 and the middle horizontal pillar 202 of the main body frame 200. On the other hand, the scanner unit 11 is arranged at a position lower than the middle horizontal pillar 202. Moreover, the maintenance unit 2600 is arranged in such a way as to extend between a position upper than the middle horizontal pillar 202 and a position lower than the middle horizontal pillar 202.

### <Size of Main Body Frame>

Here, the size in the front-back direction of the main body frame 200 is described.

As mentioned above, a plurality of sets each including, for example, the recording head 10 and the head holder 26 is included in the recording unit 2300, and the recording unit 2300 is attached to the upper horizontal pillar 201 and the middle horizontal pillar 202 of the main body frame 200. The size in the front-back direction (near-to-far dimension) of the recording unit 2300 is determined mainly by the following requirements (1) and (2):
(1) The width in the longitudinal direction (front-back direction) of the nozzle plate 223 of the recording head 10 is “the sheet width of the maximum size+a (an ink application margin region for absorbing sheet position deviation)”.
(2) In a near-to-far region of the nozzle plate 223 of the recording head 10, abutting contact portions 221 which engage with the positioning member 811 arranged for the recording head 10 to land on the print belt unit 2200 are arranged. Based on these requirements, the required near-to-far (longitudinal) dimension of the recording head 10 is determined, and, to that dimension, the dimension of the recording head raising and lowering frame 28, which has the function of raising and lowering the head holder 26 and the recording head 10, is added, so that the near-to-far dimension of the recording unit 2300 is determined.

Moreover, the near-to-far (longitudinal) dimension of the maintenance unit 2600 is determined by the following requirements (1) to (4):
(1) The near-to-far dimension of a landing configuration of the recording head 10 similar to that of the print belt unit 2200 arranged for the recording head 10 to land on a cap mechanism or a cleaning mechanism. (2) The near-to-far dimension of the cap tray 18, which holds a cap mechanism or a head landing configuration. (3) The near-to-far dimension of the cleaning tray 19, which holds a cleaning mechanism or a head landing configuration. (4) The near-to-far dimension of a rail configuration which moves the cap tray 18 and the cleaning tray 19 in the right-left direction below the recording unit 2300. Based on these requirements, the near-to-far dimension of the maintenance unit 2600 is determined.

Based on the above-mentioned two configuration requirements about the near-to-far dimension of the recording unit 2300 and the near-to-far dimension of the maintenance unit 2600, the position in the front-back direction of the middle horizontal pillar 203 in the main body frame 200 is determined. To utilize a space on the inner side of the front door 100 serving as an exterior cover described below, coupling portions of the middle horizontal pillar 202 with the left support pillar 203 and the right support pillar 204 are made to slightly deviate toward the far side.

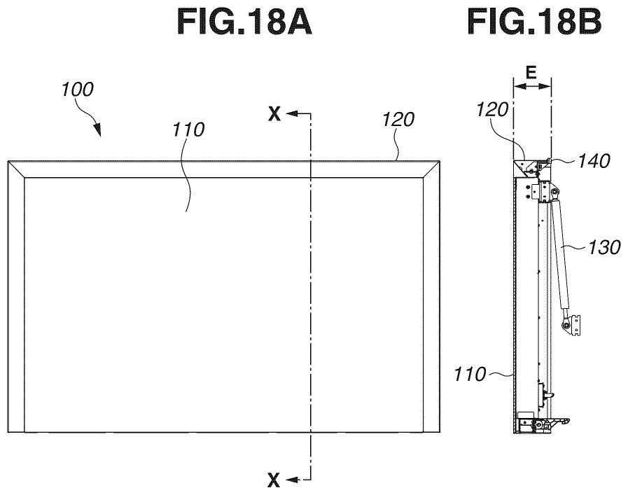

Specifically, as illustrated in FIG. 15, the middle horizontal pillar 202 includes a recessed portion 202L, a raised portion 202C, and a recessed portion 202R. In the right-left direction, the raised portion 202C is located between the recessed portion 202L and the recessed portion 202R. Thus, the middle horizontal pillar 202 extends in the right-left direction. The recessed portion 202L of the middle horizontal pillar 202 is coupled to the left support pillar 203. The recessed portion 202R of the middle horizontal pillar 202 is coupled to the right support pillar 204. In the front-back direction, the raised portion 202C is made to deviate toward the near side relative to the recessed portion 202L and the recessed portion 202R. If viewed from the opposite side, portions at both sides in the right-left direction facing a front-door frame 120 of the front door 100 described below (i.e., the recessed portion 202L and the recessed portion 202R) are made to deviate toward the far side. The raised portion 202C, which is between the recessed portion 202L and the recessed portion 202R at both sides of the middle horizontal pillar 202, falls within an internal space (a region E illustrated in FIG. 18B) surrounded by the front-door frame 120 of the front door 100. In other words, the position in the front-back direction of at least a part of the raised portion 202C is the same as the position in the front-back direction of the front-door frame 120 of the front door 100 taken when the front door 100 is in the closed state. Thus, if viewed with a line of sight along the right-left direction, the front-door frame 120 of the front door 100 and the raised portion 202C at least partially overlap each other.

In the foreside of the main body frame 200, the recording unit 2300 is attached to and held by the middle horizontal pillar 202 and the upper horizontal pillar 201. With this configuration, the recording unit 2300 is supported in such a way as to be movable in the front-back direction as illustrated in FIG. 11 and is able to be pulled out to the near side of the main body frame 200.

The middle horizontal pillar 202 is arranged between the left support pillar 203 and the right support pillar 204 in the foreside of the main body frame 200, and supports internal units such as the recording unit 2300 and the maintenance unit 2600, which is movable in the sheet conveyance direction. In the main body frame 200, there is an internal space 209, in which the recording unit 2300 and the maintenance unit 2600 are arranged, on the rear surface side of the middle horizontal pillar 202 (the side of the interior portion of the main body frame 200). During the raising and lowering operation in the vertical direction, the recording unit 2300 passes through the internal space 209 on the rear surface side of the middle horizontal pillar 202. Moreover, during the movement operation in the right-left direction, the maintenance unit 2600 passes through the internal space 209 on the rear surface side of the middle horizontal pillar 202.

Usually, it is desirable that, from the viewpoint of frame stiffness, the middle horizontal pillar 202, which has the function of supporting units, linearly joins the inside of a region sandwiched between right and left support pillars in the horizontal cross-section.

Here, in the middle horizontal pillar 202, the entirety or part of a region thereof in which the front-door frame 120 of the front door 100 is not present as viewed from the front side is protruded toward the front side relative to a space sandwiched between the left support pillar 203 and the right support pillar 204. Thus, the raised portion 202C, which is between the recessed portion 202L and the recessed portion 202R at both sides of the middle horizontal pillar 202, is protruded toward the front side relative to the left support pillar 203 and the right support pillar 204. This enables ensuring the internal space 209 on the rear surface side of the middle horizontal pillar 202 to be wider by the thickness of the front-door frame 120 of the front door 100 at a maximum, and also enables reducing the size of the entire main body frame 200 to a small value.

Moreover, a configuration described below in which the front door 100 is openable upward and a transparent cover 110 covers the entire front door 100 enables making a protrudable region in which the front-door frame 120 of the front door 100 is not present between the left and right support pillars broader and also making the protrudable region uniform. For example, in a case where the front door 100 is not openable upward but openable as divided doors opening oppositely and horizontally pivotally, a frame becomes required at a portion of division of the doors and, in that region, the protrusion of the middle horizontal pillar 202 toward the frontward direction is inhibited, so that it is impossible to make the protrudable region uniform and it becomes difficult to ensure the stiffness of the middle horizontal pillar 202.

In this way, the middle horizontal pillar 202 has a uniform protrusion shape and the stiffness of an end portion region of the middle horizontal pillar 202 which is not included in the driving paths of internal units is ensured, so that the stiffness of the middle horizontal pillar 202 is ensured.

### <Configuration of Front Door>

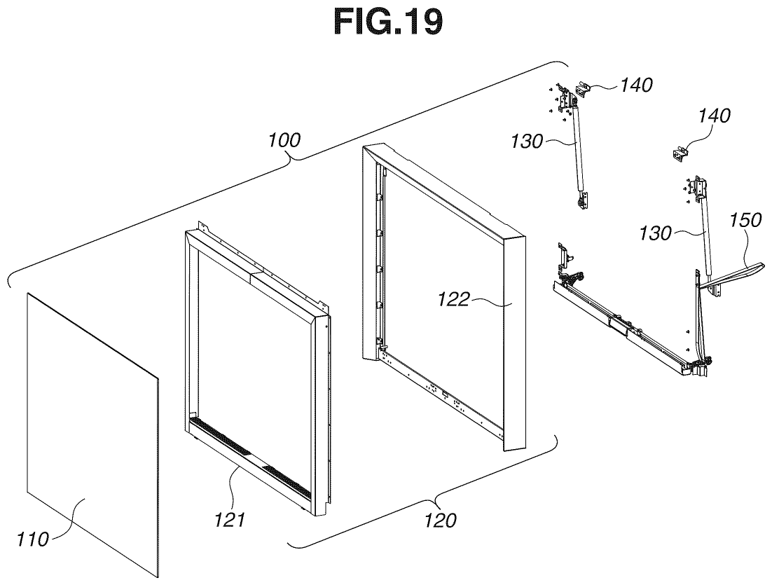

Next, the front door 100, which is an exterior cover serving as the exterior of a foreside of the print module 2000 at the near side of the recording unit 2300, is described with reference to FIG. 16, FIG. 17, FIGS. 18A and 18B, and FIG. 19. FIG. 18A is an overall schematic view of the front door 100 of the print module 2000. FIG. 18B is a sectional view of the front door 100 of the print module 2000 taken along line X-X in FIG. 18A. FIG. 19 is a configuration exploded view of the front door 100 of the print module 2000.

The print module 2000 includes the front door 100, which is an exterior cover serving as the exterior of a foreside of the print module 2000 at the near side of the recording unit 2300 in the front-back direction perpendicular to the vertical direction and the right-left direction. The front door 100 is provided at the main body frame 200 in such a way as to be openable and closable. The front door 100 includes the transparent cover 110, which is made from a transparent material over the entire area of the foreside thereof. The front door 100 is provided in such a way as to be openable and closable around the upper end thereof in the vertical direction.

Thus, the front door 100 is attached to the front side of the main body frame 200. The front door 100 includes the transparent cover 110 and the front-door frame 120, which has a certain degree of thickness to keep the stiffness of the front door 100. The front-door frame 120 is arranged in at least a part of the circumference of the transparent cover 110. In the first exemplary embodiment, the front-door frame 120 surrounds the four sides of the transparent cover 110. As a modification example, the front-door frame 120 can be configured to surround only three sides or only two sides of the transparent cover 110. Alternatively, the front-door frame 120 can be provided at only a part of one side of the transparent cover 110. The transparent cover 110 is attached to the outside in the thickness direction of the front-door frame 120. In other words, the transparent cover 110 is arranged on the front end side in the front-back direction of the front-door frame 120. The front end side mentioned here refers to a region between the center and the front end of the front-door frame 120 in the front-back direction.

Moreover, when the front door 100 is currently closed, the front-door frame 120 is in a position supported by the main body frame 200 as viewed from the front side, so that the front door 100 does not enter into the internal space 209, which is behind the middle horizontal pillar 202 of the main body frame 200.

The front door 100 is formed in such a way as to cover the entirety of a region T (see FIG. 16), which is upper than the sheet conveyance surface 24 of the print belt 2201, which conveys a sheet of paper. Additionally, the front door 100 is provided with the transparent cover 110 as illustrated in FIGS. 18A and 18B, so that the recording unit 2300 and other units inside the image forming apparatus can be visually checked from outside the image forming apparatus even during a printing operation in progress. Being able to visually check the inside of the image forming apparatus contributes to not only being able to visually check the operating status of the image forming apparatus but also being able to determine the presence or absence of the need for cleaning of the inside of the image forming apparatus caused by adhesion of ink mist.

The transparent cover 110 is configured as a single unit (front-door unit) integral with the front door 100 located above the sheet conveyance surface 24 (see FIG. 14) in such a manner that, from the viewpoint of design, not only the recording unit 2300 but also a region as broad as possible can be visually checked. The area which the transparent cover 110 occupies in the front door 100 is set in such a manner that 85% in the longitudinal direction is the transparent cover 110.

Specifically, the front-door frame 120 includes a left side portion facing the left support pillar 203 and a right side portion facing the right support pillar 204. Then, the transparent cover 110 is arranged to extend from the left side portion to the right side portion. In this way, the front door 100 is formed with the transparent cover 110 extending from the left support pillar 203 to the right support pillar 204 in the right-left direction of the main body frame 200.

Moreover, the front door 100 is formed with the transparent cover 110 extending from the upper horizontal pillar 201 to the sheet conveyance surface 24 of the print belt unit 2200 in the vertical direction of the main body frame 200. The sheet conveyance surface 24 of the print belt unit 2200 is located at a position lower than the middle horizontal pillar 202 of the main body frame 200 as illustrated in FIG. 14. Accordingly, it can also be said that the front door 100 is formed with the transparent cover 110 extending from the upper horizontal pillar 201 to the middle horizontal pillar 202 in the vertical direction of the main body frame 200.

This configuration enables visually checking the operating status of the print module 2000 via the transparent cover 110 without opening the front door 100. For example, the user can visually check, for example, the moving up and down operation and position of the recording head 10, the operation and position of the maintenance unit 2600, the position of the scanner unit 11, and the condition in which a sheet of paper is being conveyed. Moreover, the user can visually check, from outside the image forming apparatus, a dirty condition of the vicinity of the recording unit 2300 even during an operation of the image forming apparatus in progress, and can determine the necessity of cleaning.

Moreover, the transparent cover 110 is made from a transparent resin plastic material selected in view of the weight and break-proof property and is made as thin (=light) as possible within the range not spoiling the texture. Since the transparent cover 110 is a thin resin plastic material, the stiffness of the front door 100 is ensured by the thickness in the front-back direction of the front-door frame 120 (region E) being made larger than the thickness in the front-back direction of the transparent cover 110. Specifically, the thickness of the transparent cover 110 is 5 millimeters (mm), and the thickness (region E) of the front-door frame 120 is larger than the thickness of the transparent cover 110 (for example, larger than or equal to 30 mm).

Here, the front-door frame 120 has a thickness of 50 mm in the front-back direction. Moreover, the transparent cover 110 has a thickness of 5 mm in the front-back direction. The transparent cover 110 is arranged at the front end side in the front-back direction of the front-door frame 120. Thus, the transparent cover 110 is arranged at the outermost surface of the front door 100. Accordingly, the front door 100 provides an internal space of 45 mm (in the region E) at the side inner than the transparent cover 110.

Then, as illustrated in FIG. 16, arranging components of the respective elements of the image forming apparatus in the space (region E) inside the front door 100 in an embedding manner contributes to reducing the near-to-far dimension of the image forming apparatus. As illustrated in FIG. 17, in a state in which the recording unit 2300 is attached to the middle horizontal pillar 202 of the main body frame 200, the middle horizontal pillar 202 and the recording unit 2300 fall within the inside of the thickness (region E) of the front-door frame 120 of the front door 100.

In other words, with regard to the above-mentioned main body frame 200, the left support pillar 203, the right support pillar 204, and the upper horizontal pillar 201 of the main body frame 200, which face the front-door frame 120 of the front door 100 in the front-back direction, are provided in such a way as to deviate toward the far side from the front end portion of the recording unit 2300 supported by the main body frame 200. With this configuration, the size of the main body frame 200 is reduced, and the front end portion in the front-back direction of the recording unit 2300 is embedded into an internal space corresponding to the thickness (45 mm) in the front-back direction of the front-door frame 120 of the front door 100.

Specifically, as mentioned above, the recording unit 2300 includes the handle 13 at the front end in the front-back direction of the recording head raising and lowering frame 28. The recording unit 2300 is supported in such a way as to be movable in the front-back direction relative to the main body frame 200. The handle 13 is arranged in an internal space (region E) surrounded by the front-door frame 120 of the front door 100 and located on the front side of the upper horizontal pillar 201 of the main body frame 200. In other words, the position in the front-back direction of at least a part of the handle 13 is the same as the position in the front-back direction of the front-door frame 120 of the front door 100 being in a closed state. Thus, if viewed from a line of sight along the right-left direction, the front-door frame 120 of the front door 100 and the handle 13 at least partially overlap each other.

Moreover, as mentioned above, the scanner unit 11 includes the handle 402 at the front end in the front-back direction of the scanner unit 11. The handle 402 is arranged in an internal space (region E) surrounded by the front-door frame 120 of the front door 100 and located on the front side of the upper horizontal pillar 201 of the main body frame 200.

In this way, forming an internal space (region E) with a thickness in the front-back direction at the front-door frame 120 of the front door 100 contributes to reducing the near-to-far dimension of the image forming apparatus.

The configuration of the front door 100 is further described in detail with reference to FIG. 19. The front door 100 includes the transparent cover 110, the front-door frame 120, which forms the circumference of the transparent cover 110, gas springs 130, which assist opening and closing forces, an upper hinge 140, and a hanging string 150.

The front-door frame 120 of the front door 100 is designed to have two paint colors applied thereto. The front-door frame 120 is composed of a first frame 121 and a second frame 122. The first frame 121 is formed by welding and fastening a plurality of parts into a square shape and then performing paint application thereon. The second frame 122 is formed by welding and fastening a plurality of parts into a square shape and then performing paint application thereon with a color different from that of the first frame 121. The front-door frame 120 is formed by the first frame 121 and the second frame 122 being fastened with screws after being painted. The reason for, after welding the first frame 121 and the second frame 122, each of which is composed of a plurality of parts, performing painting thereon is to ensure adequate stiffness in the state of being fabricated in a square shape.

The transparent cover 110 is bonded and fixed by adhesive agent to the front end side in the front-back direction of the front-door frame 120. Additionally, the gas springs 130, the upper hinge 140, and the hanging string 150 are attached to the respective predetermined positions of the front-door frame 120.

### <Opening and Closing of Front Door>

The front door 100 has the upper hinge 140 attached to the upper end thereof, and the upper hinge 140 is attached to the upper horizontal pillar 201 of the main body frame 200. The front door 100 pivots (or rotates, turns) around the upper hinge 140 to take an opened state and a closed state. In this way, the front door 100 is supported by the main body frame 200 in such a way as to be able to be opened and closed.

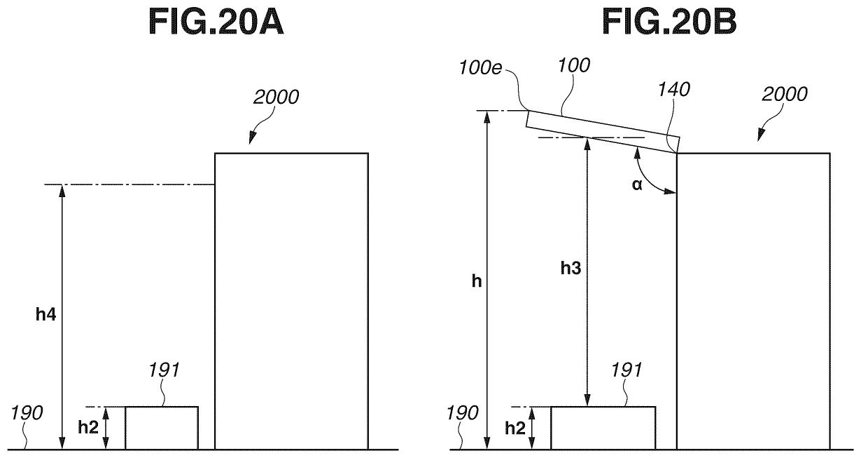

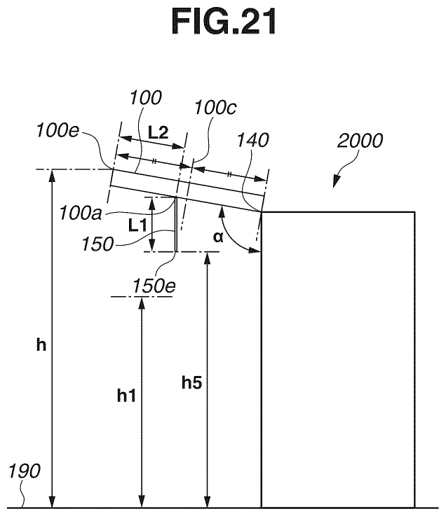

An opening and closing operation of the front door 100 of the print module 2000 is described with reference to FIG. 3, FIGS. 20A and 20B, and FIG. 21. FIGS. 20A and 20B are diagrams illustrating a state in which the front door 100 of the print module 2000 is upward opened. FIG. 21 is a diagram used to explain the hanging string 150 of the front door 100 in a state in which the front door 100 is upward opened.

The front door 100, which covers the recording unit 2300 of the print module 2000, is upward opened around the upper end base point of the print module 2000 as illustrated in FIG. 3. The front door 100 is provided with a lever (not illustrated) for releasing a latch at the middle of the lower side thereof. When the user grips the lever and releases the latch, the front door 100 opens upward around the upper hinge 140 and then collides with a stopper (not illustrated) provided at a fully opened position while being assisted by the gas springs 130, so that the fully opened state of the front door 100 is maintained.

If the front door 100 is not an upward opening door but is double doors pivotally and oppositely opening in the right-left direction, after the operator pulls out the recording unit 2300 from the print module 2000 to the near side at the time of a replacement operation for the recording head 10, the operator is not able to ensure adequate space for going around to the left side of the recording unit 2300 and performing the replacement operation, so that the replacement operation is difficult to perform. Therefore, it is favorable that the front door 100 is an upward opening door. Moreover, since the image forming apparatus according to the first exemplary embodiment is configured with a plurality of modules having respective different functions sequentially coupled, in a case where an error or jam has occurred and, thus, staying of sheets of paper has occurred inside the main body of the image forming apparatus, the operator needs to sequentially access the plurality of modules. In such a case, from a standpoint of not disturbing a lateral movement to a module next to the print module 2000, it is also favorable that the front door 100 is an upward opening door.

Thus, making the front door 100 openable upward prevents the lateral movement to a module next to the print module 2000 from being disturbed by the opened front door 100 at the time of processing for a jam extending to a plurality of modules. Moreover, making the front door 100 openable upward enables easily gaining access to the side surface of the recording unit 2300 pulled out to the near side at the time of replacement of the recording head 10 and thus enables easily performing such replacement. Moreover, providing the transparent cover 110 at the front door 100 made openable upward enables obtaining an advantageous effect in which, even when the front door 100 is opened, illumination from a ceiling enters the inside of the image forming apparatus through the transparent cover 110 and, thus, the inside of the image forming apparatus is made easily viewable.

The maximum open angle a of the front door 100 when the front door 100 is opened upward around the above-mentioned upper end is set in the following way. The height in the vertical direction from the mounting surface 190 of the image forming apparatus to the free end 100e of the front door 100, which is the lower end thereof, in the position where the front door 100 has been opened to the maximum open angle is denoted by h. The lower limit of the body height of the operator is denoted by h1 (for example, 1,470 mm), and the upper limit of the body height of the operator is denoted by h3 (for example, 1,970 mm). Moreover, a predetermined height of the workbench 191 for the operator with the body height lower limit h1 is denoted by h2 (for example, 320 mm). Moreover, the height h4 illustrated in FIG. 20A is the height from the mounting surface 190 to the eyes (eye height) of the operator with the body height lower limit value h1 who has gotten on top of the workbench 191, and the height h2 of the workbench 191 is set in such a manner that the eye height h4 becomes a predetermined height (for example, 1,670 mm). The maximum open angle a of the front door 100 is set to the open angle a taken when the height h in the vertical direction to the free end 100e of the front door 100 becomes larger than the height (h3+h2) in the vertical direction taken when the operator with the body height upper limit h3 has gotten on top of the workbench 191 with the predetermined height h2, which is provided essentially for the operator with the body height lower limit h1.

Specifically, the open angle a around the above-mentioned upper end of the front door 100 is set to 100°+10°.

To access the maintenance unit 2600, the short operator with the body height lower limit h1 needs to get on top of the workbench 191 with the height h2 as illustrated in FIG. 20A. Moreover, it is necessary that, even when the tall operator with the body height upper limit h3 gets on top of the workbench 191, the head of such a tall operator does not collide with the front door 100 opened upward (FIG. 20B). From the viewpoint of such human scale, the open angle a around the above-mentioned upper end of the front door 100 is set.

However, in a state in which the front door 100 is open at an open angle of 100°, the short operator is not able to close the front door 100 because of not reaching the forefront (free end 100e) of the front door 100 with the hand. Therefore, as illustrated in FIG. 21, the front door 100 includes the hanging string 150 for assisting a closing operation for closing the front door 100. The hanging string 150 is attached to the inner side of the front door 100. In this way, the hanging string 150 is provided at the inner side of the front door 100, so that, first, the operator can lower the front door 100 by pulling the hanging string 150 and then close the front door 100 by putting the operator's other hand on the forefront portion of the front door 100.

Moreover, in a case where the hanging string 150 is too long or the attachment position of the hanging string 150 is too close to the forefront side of the front door 100, when the front door 100 has been closed, the hanging string 150 sticks out of the front door 100, so that the quality of the outer appearance of the image forming apparatus is disturbed. On the other hand, in a case where the hanging string 150 is too short, the short operator is not able to reach the hanging string 150 with the hand and is thus not able to close the front door 100. Moreover, in a case where the attachment position of the hanging string 150 is too close to the base side of the front door 100, when the front door 100 has been closed, the front door 100 may collide with the operator.

From these viewpoints, in the front door 100, which is openable upward around the upper end base point of the print module 2000, the hanging string 150 is attached to the position nearer to the free end side than the central portion 100c between the upper end (upper hinge 140) serving as an opening and closing pivot point of the front door 100 and the free end 100e.

Moreover, the entire length L1 of the hanging string 150 is set shorter than the length L2 from the attachment position 100a of the front door 100 for the hanging string 150 to the free end 100e of the front door 100.

Moreover, in the position where the front door 100 has been opened to the maximum open angle a, the height h5 from the mounting surface 190 of the image forming apparatus to the lower end 150e of the hanging string 150 is less than or equal to a setting value which the operator with the body height lower limit h1 is able to reach with the hand.

Specifically, the upper limit height h5 of the hanging string 150 is 1,700 mm, and the attachment position 100a for the hanging string 150 is set to 360 mm from the forefront (free end 100e) of the front door 100 in the front-back direction. As a result, in a case where the operator with the body height lower limit h1 closes the front door 100, the angle of the arm taken when the operator puts the index finger on the hanging string 150 becomes about 160°, thus enabling causing the operator with the body height lower limit h1 to be present outside a turning trajectory of the front door 100, and, even if the operator with the body height lower limit h1 has closed the front door 100, it is possible to avoid the front door 100 from colliding with such an operator.

Furthermore, the image forming apparatus according to the first exemplary embodiment is required to be provided with an interlock and a door lock from the viewpoint of safety, and is specified in such a manner that, during an operation of the image forming apparatus in progress, even when the operator grips a latch lever, the latch is not released, so that the operator is not able to open the front door 100.

In the first exemplary embodiment, since the front door 100 provided at the foreside of the image forming apparatus is an upward opening door, it is possible to reduce the limitation of a work space which is caused by the front door 100 being opened when the operator performs a maintenance operation for the image forming apparatus while opening the front door 100. Accordingly, it is possible to provide an image forming apparatus the operability of which has been improved. However, the direction in which the front door 100 opens is optional, and the front door 100 can be a horizontally opening door or a downward opening door.

Moreover, as mentioned above, for example, a recording unit, a handle of the recording unit, a middle horizontal pillar, a maintenance unit, a reading unit, and a conveyance belt can be visually checked through the transparent cover 110 in a state in which the front door 100 is closed. With regard to the respective elements, only some of the elements can be visually checked or all of the elements can be visually checked. Moreover, out of the above-mentioned elements, some elements (for example, the reading unit) can be configured not to be visually checked. The transparent cover 110 is configured to be arranged at the front door 100 serving as an upward opening door which covers the foreside of the image forming apparatus. Therefore, as compared with a door configuration of divided doors opening oppositely and horizontally pivotally, it is possible to broaden the range available for visually checking the operating status of the image forming apparatus. As a result, it is possible to provide an image forming apparatus the operability of which has been improved.

### <Upper Hinge>

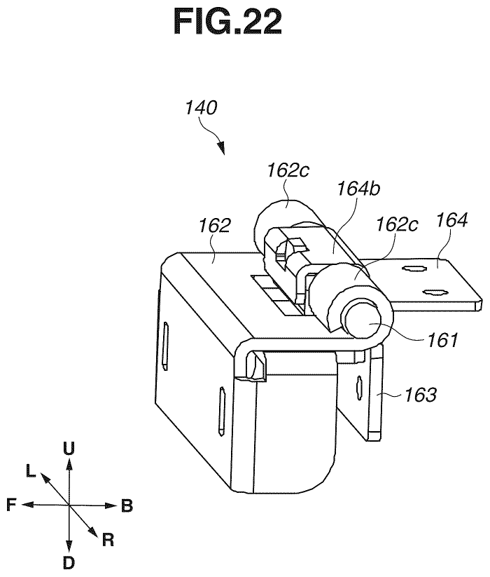

The upper hinge 140, which is used for the front door 100, is described in detail with reference to FIG. 22 to FIG. 28.

FIG. 22 is a perspective view illustrating the upper hinge 140. To illustrate the structure of the upper hinge 140, FIG. 22 illustrates the upper hinge 140 in a state of having been detached from the front door 100 and the main body frame 200. As illustrated in FIG. 22, the upper hinge 140 includes a shaft member 161, a shaft supporting member 162, a shaft supporting member 163, and a restriction member 164. The front door 100 is provided with a plurality of upper hinges 140. Each of the plurality of upper hinges 140 equally has the configuration illustrated in FIG. 22. In the following description, the respective members are described.

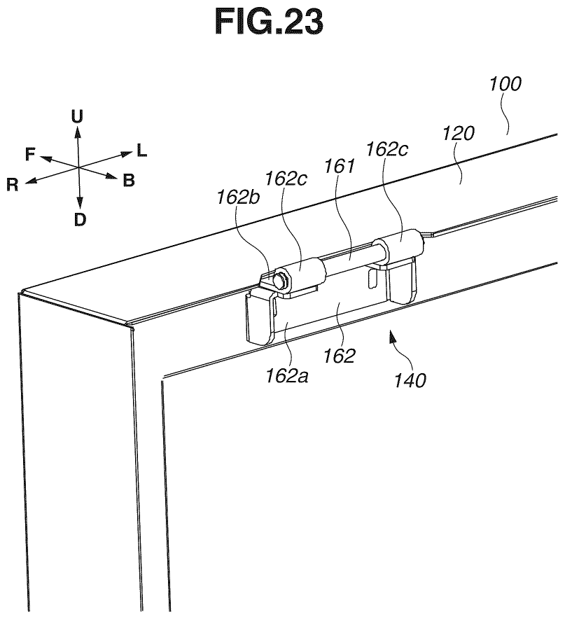

FIG. 23 is a perspective view of parts of the front door 100 and the upper hinge 140 as viewed from behind. The shaft supporting member 162 of the upper hinge 140 is fixed to the back side of the front-door frame 120 of the front door 100. The shaft supporting member 162 is made from sheet metal. A part of the shaft supporting member 162 is subjected to bending work, so that ring-shaped portions 162c, through which the shaft member 161 is inserted, are formed. Specifically, first, the shaft supporting member 162 includes a facing portion 162a, which serves as a surface facing the front-door frame 120. Additionally, the shaft supporting member 162 includes a bent portion 162b, which has been formed by bending and raising of the upper end of the facing portion 162a. Bending work is further performed on the forefront of the bent portion 162b, i.e., a portion of the bent portion 162b opposite to the upper end of the facing portion 162a, so that the ring-shaped portions 162c are formed. One shaft supporting member 162 includes two ring-shaped portions 162c. The single shaft member 161 is inserted through the two ring-shaped portions 162c. The shaft supporting member 162 only needs to include one ring-shaped portion 162c.

The shaft member 161 is made from metal. The shaft member 161 is cylindrical. The shaft member 161 is inserted through the ring-shaped portions 162c of the shaft supporting member 162 in such a manner that, according to turning of the front door 100, the shaft member 161 and the shaft supporting member 162 turn in a follow-up manner. Moreover, a load caused by the movement of the front door 100 is applied to the ring-shaped portions 162c of the shaft supporting member 162. Even in this case, the ring-shaped portions 162c of the shaft supporting member 162 have such a degree of strength as to prevent the shaft member 161 from coming off from the ring-shaped portions 162c. Furthermore, the shaft supporting member 162 being made from metal such as sheet metal enables obtaining high durability. However, the shaft supporting member 162 can be made from, for example, plastic depending on the required strength. The same also applies to the other members of the upper hinge 140.

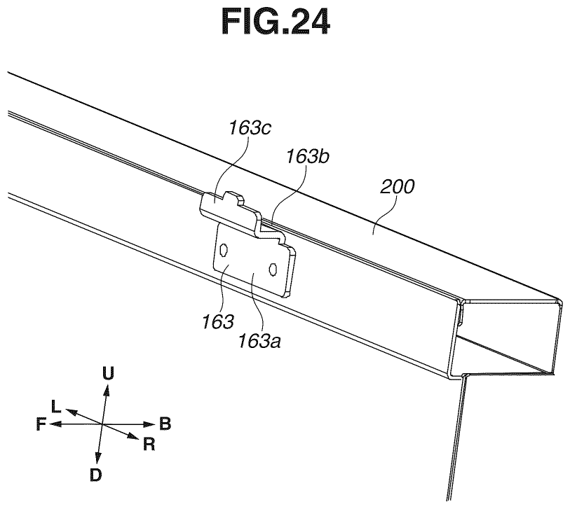

FIG. 24 is a perspective view of parts of the main body frame 200 and the upper hinge 140 as viewed from the front. The shaft supporting member 163 of the upper hinge 140 is fixed to the foreside of the main body frame 200. The shaft supporting member 163 is made from sheet metal. A part of the shaft supporting member 163 is subjected to bending work, so that a holding portion 163b, which holds the shaft member 161, is formed. Specifically, first, the shaft supporting member 163 includes a facing portion 163a, which serves as a surface facing the main body frame 200. A portion which has been formed by bending and raising of the upper end of the facing portion 163a is the holding portion 163b. The shaft member 161 is held on the upper surface of the holding portion 163b. Bending work is further performed on the forefront of the holding portion 163b, i.e., a portion of the holding portion 163b opposite to the facing portion 163a. A bent portion provided at the forefront of the holding portion 163b constitutes a restriction portion 163c which restricts the movement of the shaft member 161 (eventually, the front door 100) toward the near side (in the radial direction of the shaft member 161). Furthermore, the upper end of the restriction portion 163c has a raised portion (protruding portion).

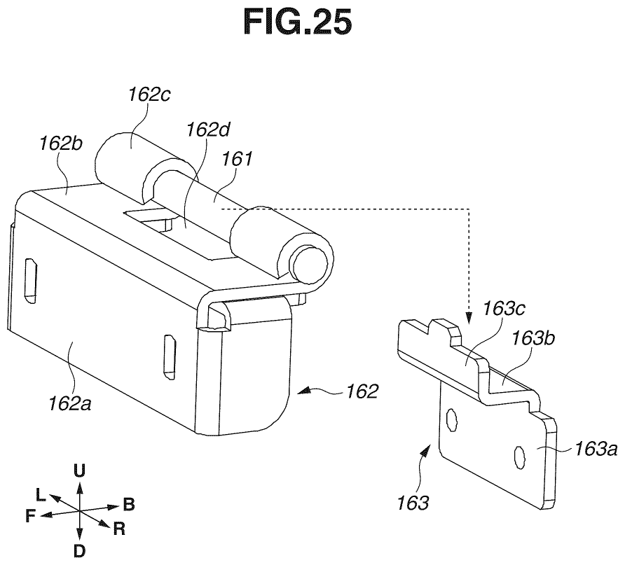

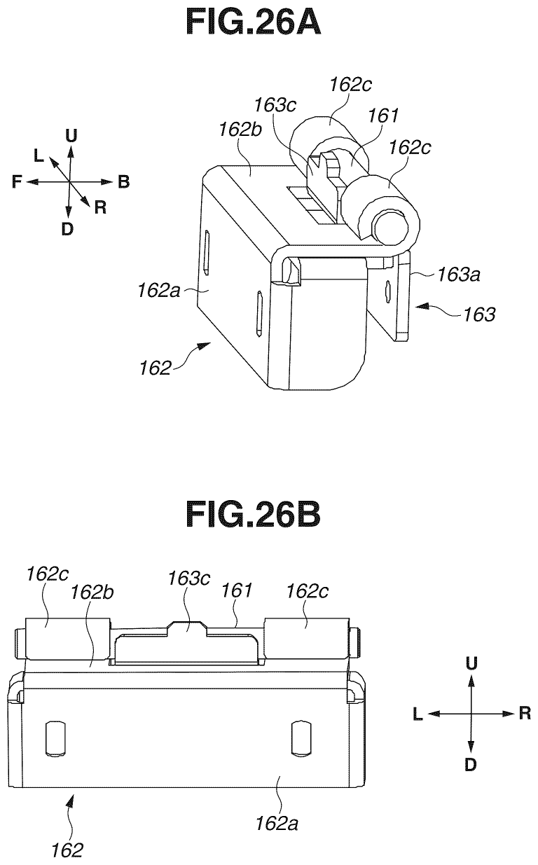

Coupling between the shaft supporting member 162 and the shaft supporting member 163 is described with reference to FIG. 25 and FIGS. 26A and 26B. FIG. 25 is a perspective view illustrating a part of the upper hinge 140. FIGS. 26A and 26B are a perspective view and a front view, respectively, illustrating a part of the upper hinge 140. FIG. 25 illustrates the process of coupling the shaft supporting member 162 and the shaft supporting member 163 with each other. On the other hand, FIGS. 26A and 26B illustrate a state in which the shaft supporting member 162 and the shaft supporting member 163 have been coupled with each other.

As illustrated in FIG. 25, the bent portion 162b of the shaft supporting member 162 is provided with an opening 162d. The opening 162d is located between the two ring-shaped portions 162c. In a state in which the shaft member 161 has been placed on the upper surface of the holding portion 163b of the shaft supporting member 163, the restriction portion 163c of the shaft supporting member 163 is inserted through the opening 162d of the shaft supporting member 162. With such a configuration, the restriction portion 163c restricts the movement of the shaft supporting member 162 (eventually, the front door 100) in the right-left direction (in the thrust direction of the shaft member 161). Thus, by the shaft supporting member 162 and the shaft supporting member 163 being coupled with each other as illustrated in FIGS. 26A and 26B, the movement of the front door 100 toward the near side and the movement of the front door 100 in the right-left direction relative to the main body frame 200 are restricted.

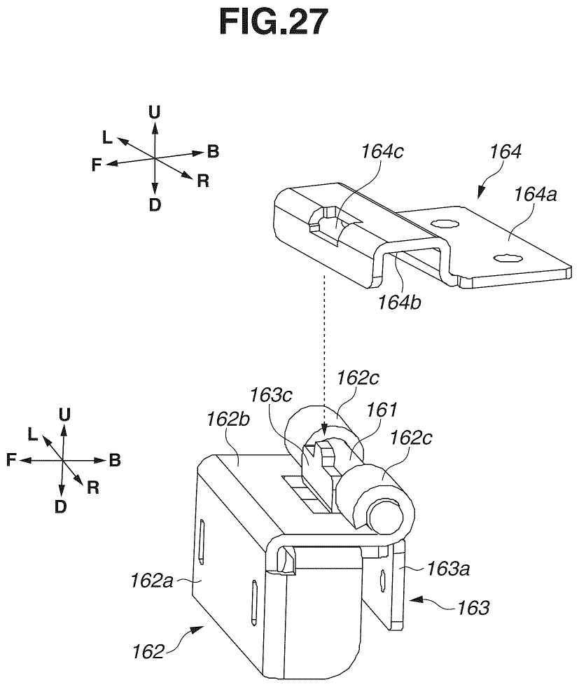

FIG. 27 is a perspective view illustrating the upper hinge 140. The restriction member 164 is additionally attached to the shaft supporting member 162 and the shaft supporting member 163 coupled with each other. The restriction member 164 of the upper hinge 140 is fixed to the upper surface of the main body frame 200 (not illustrated in FIG. 27).

The restriction member 164 is made from sheet metal. A part of the restriction member 164 is subjected to bending work, so that a shaft cover 164b is formed. Specifically, first, the restriction member 164 includes a facing portion 164a, which serves as a surface facing the upper surface of the main body frame 200. The shaft cover 164b is formed by bending work being performed on a front side portion of the facing portion 164a. When taken along a cross-section containing the front-back direction and the upward and downward directions, the cross-section of the shaft cover 164b is of a U-shaped form which is open at the bottom. Thus, the shaft cover 164b has a recessed portion formed therein as viewed from the underside. The shaft member 161 and the restriction portion 163c of the shaft supporting member 163 are contained in the recessed portion of the shaft cover 164b. The length in the right-left direction of the shaft cover 164b is equal to the interval between two ring-shaped portions 162c of the shaft supporting member 162 or is shorter than such an interval. Accordingly, as illustrated in FIG. 22, in a state in which the restriction member 164 has been attached to the shaft supporting member 162 and the shaft supporting member 163 coupled with each other, the shaft cover 164b is arranged between the two ring-shaped portions 162c.

Referring back to FIG. 27, the shaft cover 164b is provided with an opening 164c. In a state in which the shaft member 161 and the restriction portion 163c of the shaft supporting member 163 have been contained in the recessed portion of the shaft cover 164b, the raised portion of the upper end of the restriction portion 163c is inserted through the opening 164c.

In this way, with the restriction member 164 being attached to the shaft supporting member 162 and the shaft supporting member 163 coupled with each other, the restriction member 164 restricts the movement of the shaft member 161 (eventually, the front door 100) in the upward direction. As mentioned above, the restriction portion 163c of the shaft supporting member 163 restricts the movement of the front door 100 toward the near side. Thus, by the restriction member 164 and the restriction portion 163c of the shaft supporting member 163, in the radial direction of the shaft member 161, the relative position of the front door 100 to the main body frame 200 is restricted. Moreover, by the restriction portion 163c of the shaft supporting member 163, even in the thrust direction of the shaft member 161, the front door 100 is relatively positioned with respect to the main body frame 200.

In a state in which the restriction member 164 has been attached to the shaft supporting member 162 and the shaft supporting member 163 coupled with each other, the middle portion of the shaft member 161 is arranged in a region surrounded by (1) the restriction portion 163c of the shaft supporting member 163, (2) the holding portion 163b of the shaft supporting member 163, and (3) the shaft cover 164b of the restriction member 164. When the shaft member 161 and the shaft supporting member 162 turn according to turning of the front door 100, the shaft member 161 relatively turns with respect to the restriction portion 163c, the holding portion 163b, and the shaft cover 164b. In the radial direction and thrust direction of the shaft member 161, the relative position of the front door 100 to the main body frame 200 is restricted. Accordingly, the degree of freedom of the relative movement of the front door 100 to the main body frame 200 is only in the rotational direction centering on the extension direction of the shaft member 161. With such a configuration, the shaft member 161, the shaft supporting member 162, the shaft supporting member 163, and the restriction member 164 implement the function of the upper hinge 140.

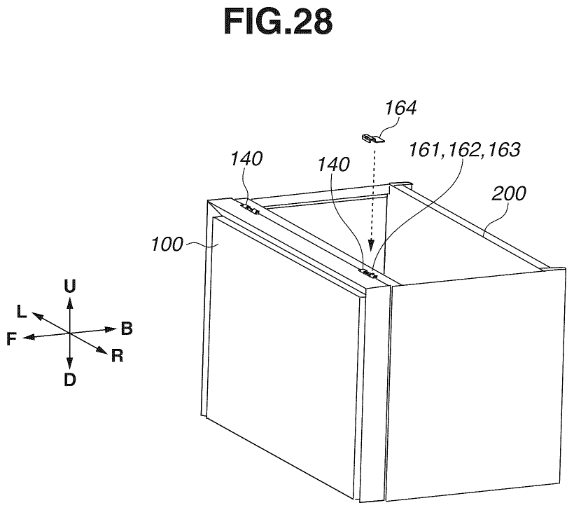

Next, the states of the front door 100 and the main body frame 200 occurring at the time of attaching the restriction member 164 are described. FIG. 28 is a perspective view illustrating the front door 100, the main body frame 200, and the upper hinge 140.

In a state in which the shaft supporting member 162 and the shaft supporting member 163 have been coupled with each other as illustrated in FIGS. 26A and 26B, the holding portion 163b of the shaft supporting member 163 is supporting the shaft member 161. At this time, if an external force from the operator is not given to the front door 100, the front door 100 is in a state of being closed by the weight of the front door 100 itself. In a more precise sense, a moment caused by the weight of the front door 100 itself around the shaft member 161 or the holding portion 163b serving as a pivot point acts on the front door 100, so that the front door 100 becomes still and stable in the position in which the acting moment reaches equilibrium. In the first exemplary embodiment, the direction of a movement caused by the weight of the front door 100 itself is a direction in which the front door 100 closes. Then, since, in the closed position, the front door 100 comes into contact with the main body frame 200 and receives a force balanced with the moment, the front door 100 becomes still and stable in the closed position.

As described above, coupling the shaft supporting member 162 and the shaft supporting member 163 with each other enables holding the front door 100 relative to the main body frame 200 in a state in which the front door 100 temporarily remains still. The state in which, in this way, no force is applied to the front door 100 excluding a force for supporting the front door 100 at, for example, the coupling portion and contact portion and a gravitational force which is applied to the front door 100 is referred to as “the front door 100 being in a free state”.

In the first exemplary embodiment, as illustrated in FIG. 28, when the front door 100 is in a free state, the shaft member 161, the shaft supporting member 162, and the shaft supporting member 163 of the upper hinge 140 are exposed upward. Thus, a region to which the restriction member 164 is attached is exposed above the image forming apparatus. Moreover, as illustrated in FIG. 27, the restriction member 164 is attached from above. Therefore, it is possible to, while maintaining the front door 100 in a free state, attach the restriction member 164 to the shaft supporting member 162 and the shaft supporting member 163. Moreover, naturally, it is possible to, while maintaining the front door 100 in a free state, detach the restriction member 164 from the shaft supporting member 162 and the shaft supporting member 163. Thus, with the front door 100 kept in a free state, the restriction member 164 is attachable to and detachable from the shaft supporting member 162 and the shaft supporting member 163. Such a configuration enables facilitating an operation for attaching the front door 100 to the main body frame 200.

Thus far is the description of the configuration of the upper hinge 140 in the first exemplary embodiment. Next, a modification example of the upper hinge 140 is described.

In the above-described first exemplary embodiment, the restriction member 164 plays the role of restricting the position in the radial direction of the shaft member 161. However, the restriction member 164 can be the one which restricts the position of the front door 100 relative to the main body frame 200 in an optional direction (for example, in the thrust direction). Additionally, the restriction member 164 can be configured to restrict the position not only in one direction but also in a plurality of directions.

Moreover, in the above-described first exemplary embodiment, the upper hinge 140, which is attached to the upper portion of the front door 100, is employed. However, a hinge of the front door 100 can be configured to be attached to an optional position of the front door 100. For example, the position at which to attach the hinge can be a lateral portion of the front door 100. In this case, the shaft member 161, the shaft supporting member 162, and the shaft supporting member 163 are laterally exposed. Then, the restriction member 164 is configured to be attached from a lateral direction.

Moreover, an example in which each member constituting the upper hinge 140 is a single component which is formed from one piece of sheet metal subjected to bending work has been described. However, each of the shaft member 161, the shaft supporting member 162, the shaft supporting member 163, and the restriction member 164 can be formed from a plurality of components coupled with each other or welded with each other.

In the above-described first exemplary embodiment, the restriction member 164 is a member serving as a part of an exterior of the image forming apparatus. However, an exterior cover which covers the restriction member 164 can also be added.

Next, a second exemplary embodiment is described. In the above-described first exemplary embodiment, the configuration of what is called an upper hinge, in which a hinge portion of the front door is provided at the upper portion thereof, has been described. On the other hand, in the second exemplary embodiment, the configuration of what is called a lateral hinge, in which a hinge portion of the front door is provided at the lateral portion thereof, is described.

The image forming apparatus in the second exemplary embodiment differs from the image forming apparatus in the above-described first exemplary embodiment mainly in a configuration in which, in the image forming apparatus in the second exemplary embodiment, a hinge portion of the front door is provided at the lateral portion of the front door. The other configurations are the same as those in the image forming apparatus in the first exemplary embodiment and are, therefore, omitted from description here.

### <Lateral Hinge>

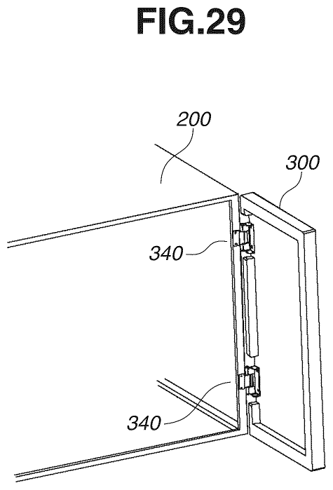

A lateral hinge 340, which is used for a front door 300, is described in detail with reference to FIG. 29 to FIG. 37.

FIG. 29 is an outline perspective view of the front door 300 provided with lateral hinges 340. The lateral hinges 340 are attached to a lateral portion of the main body frame 200. The front door 300 is supported by the main body frame 200 via the lateral hinges 340 in such a way as to be able to rotate in the lateral opening direction.

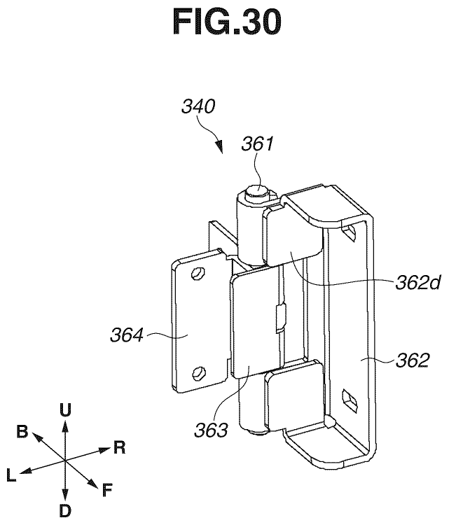

FIG. 30 is a perspective view illustrating the lateral hinge 340. To illustrate the structure of the lateral hinge 340, FIG. 30 illustrates the lateral hinge 340 in a state of having been detached from the front door 300 and the main body frame 200. As illustrated in FIG. 30, the lateral hinge 340 includes a shaft member 361, a first shaft supporting member 362, a second shaft supporting member 363, and a restriction member 364. The front door 300 is provided with a plurality of upper hinges 340. Each of the plurality of upper hinges 340 equally has the configuration illustrated in FIG. 30. Furthermore, the front door 300 can be provided with only one lateral hinge 340. In the following description, the respective members are described.

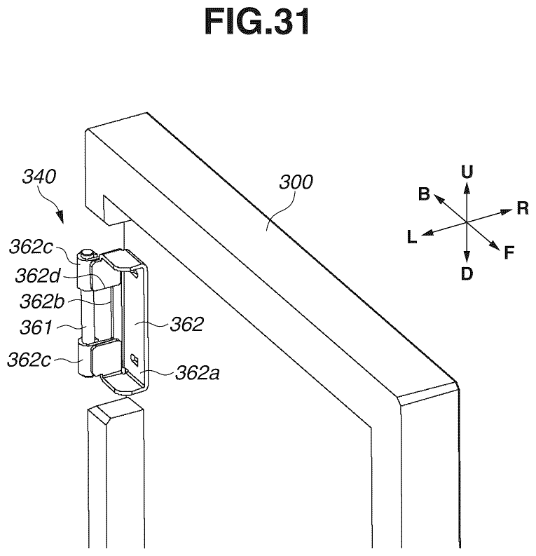

FIG. 31 is a perspective view of parts of the front door 300 and the lateral hinge 340 as viewed from inside. The shaft supporting member 362 of the lateral hinge 340 is fixed to the back side of the front door 300. The shaft supporting member 362 is made from sheet metal. A part of the shaft supporting member 362 is subjected to bending work, so that ring-shaped portions 362c, through which the shaft member 361 is inserted, are formed. Specifically, first, the shaft supporting member 362 includes a facing portion 362a, which serves as a surface facing the back side of the front door 300. Additionally, the shaft supporting member 362 includes a bent portion 362b, which has been formed by bending and raising of the end portion of the facing portion 362a. Bending work is further performed on the forefront of the bent portion 362b, so that the ring-shaped portions 362c are formed. One shaft supporting member 362 includes two ring-shaped portions 362c. The single shaft member 361 is inserted through the two ring-shaped portions 362c. The shaft supporting member 362 only needs to include one ring-shaped portion 362c. A lower ridge line portion 362d is formed between the bent portion 362b and the ring-shaped portion 362c.

The shaft member 361 is made from metal. The shaft member 361 is cylindrical. The shaft member 361 is inserted through the ring-shaped portions 362c of the shaft supporting member 362 in such a manner that, according to turning of the front door 300, the shaft member 361 and the shaft supporting member 362 turn in a follow-up manner. Moreover, a load caused by the movement of the front door 300 is applied to the lower ridge line portion 362d of the shaft supporting member 362. Even in this case, the shaft supporting member 362 have such a degree of strength as to prevent the shaft member 362 from being broken. Furthermore, the shaft supporting member 362 being made from metal such as sheet metal enables obtaining high durability. However, the shaft supporting member 362 can be made from, for example, plastic depending on the required strength. The same also applies to the other members of the lateral hinge 340.

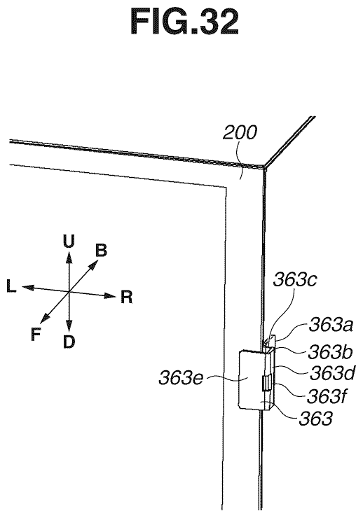

FIG. 32 is a perspective view of parts of the main body frame 200 and the lateral hinge 340 as viewed from the front. The shaft supporting member 363 of the lateral hinge 340 is fixed to the main body frame 200. The shaft supporting member 363 is made from sheet metal. A part of the shaft supporting member 363 is subjected to bending work, so that an upper ridge line portion 363c, which holds the shaft supporting member 362, is formed. Specifically, first, the shaft supporting member 363 includes a facing portion 363a, which serves as a surface facing the main body frame 200. The shaft supporting member 363 is bent and raised a plurality of times from the end portion of the facing portion 363a, so that a bent portion 363b, a restriction portion 363d, and a restriction portion 363e are formed in sequence, and an upper ridge line portion of those portions is the upper ridge line portion 363c, which holds the shaft supporting member 362. In a state in which the shaft supporting member 363 has held the shaft supporting member 362, the restriction portion 363d restricts the movement in some of the right-left direction of the shaft member 361 (eventually, the front door 300) (in some of the rightward and leftward radial directions of the shaft member 361), and the bent portion 363b and the restriction portion 363e restrict the movement in the front-back direction of the shaft member 361 (eventually, the front door 300) (in the frontward and backward radial directions of the shaft member 361). Furthermore, a bent portion at the base of the restriction portion 363e has an opening 363f described below, through which the shape of a part of the restriction member 364 is inserted.

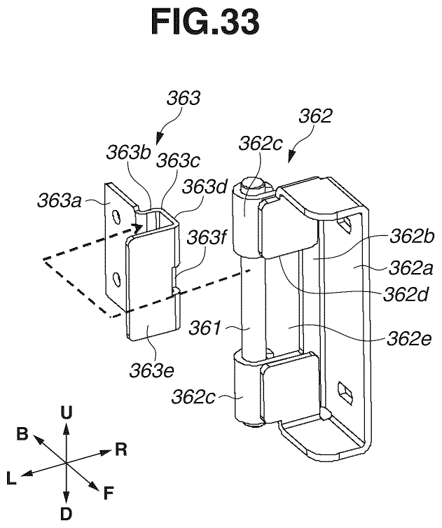

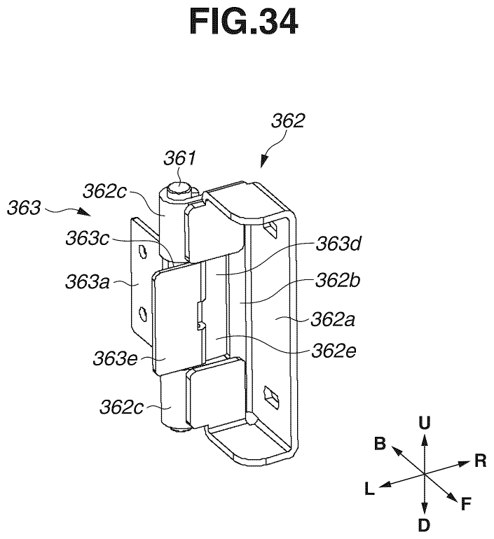

Coupling between the shaft supporting member 362 and the shaft supporting member 363 is described with reference to FIG. 33 and FIG. 34. FIG. 33 and FIG. 34 are perspective views each illustrating a part of the lateral hinge 340. FIG. 33 illustrates the process of coupling the shaft supporting member 362 and the shaft supporting member 363 with each other. On the other hand, FIG. 34 illustrate a state in which the shaft supporting member 362 and the shaft supporting member 363 have been coupled with each other.

As illustrated in FIG. 33, the bent portion 362b of the shaft supporting member 362 is provided with an opening 362e. The opening 362e is located between the two ring-shaped portions 362c. In a state in which the shaft supporting member 362 has been placed on the upper surface of the upper ridge line portion 363c of the shaft supporting member 363, the restriction portion 363e of the shaft supporting member 363 is inserted through the opening 362e of the shaft supporting member 362. With such a configuration, the restriction portion 363e restricts the movement of the shaft supporting member 362 (eventually, the front door 300) in the upward and downward directions (in the thrust direction of the shaft member 361). Thus, by the shaft supporting member 362 and the shaft supporting member 363 being coupled with each other as illustrated in FIG. 34, the movement of the front door 300 in the front-back direction, the movement of the front door 300 in the upward and downward directions, and the movement of the front door 300 in some of the right-left direction relative to the main body frame 200 are restricted.

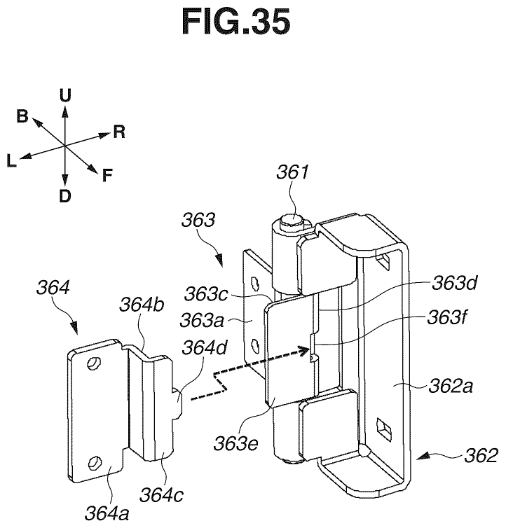

FIG. 35 is a perspective view illustrating the lateral hinge 340. The restriction member 364 is additionally attached to the shaft supporting member 362 and the shaft supporting member 363 coupled with each other. The restriction member 364 of the lateral hinge 340 is fixed to the foreside of the main body frame 200 (not illustrated in FIG. 35).

The restriction member 364 is made from sheet metal, and has a first shaft cover portion 364b and a second shaft cover portion 364c formed therein. Specifically, first, the restriction member 364 includes a facing portion 364a, which serves a face facing the foreside of the main body frame 200. Portions of the front side of the facing portion 364a are subjected to bending work in sequence, so that the shaft cover portion 364b and the shaft cover portion 364c are formed. After the restriction member 364 is attached, the shaft cover portion 364c is inserted through between the shaft member 361 and the restriction portion 363e. The length in the upward and downward directions of the shaft cover portion 364b is equal to the interval between the two ring-shaped portions 362c of the shaft supporting member 362 or is shorter than such an interval. Accordingly, in a state in which the restriction member 364 has been attached as illustrated in FIG. 30, the shaft cover portion 364b is arranged between the two ring-shaped portions 362c, the shaft cover portion 364c restricts the movement in the front-back direction of the shaft member 361, and the shaft cover portion 364b restricts the movement in some of the right-left direction of the shaft member 361. Thus, after the restriction member 364 is attached, the shaft member 361 is contained while being surrounded by the bent portion 363b and the restriction portion 363d of the shaft supporting member 363 and the shaft cover portion 364b and the shaft cover portion 364c of the restriction member 364.

Referring back to FIG. 35, the shaft cover portion 364c is provided with a raised portion 364d. In a state in which the shaft member 361 has been contained while being surrounded by the bent portion 363b and the restriction portion 363d of the shaft supporting member 363 and the shaft cover portion 364b and the shaft cover portion 364c of the restriction member 364, the raised portion 364d is inserted through the opening 363f of the shaft supporting member 363.

In this way, with the restriction member 364 being attached to the shaft supporting member 362 and the shaft supporting member 363 coupled with each other, the relative position of the front door 300 with respect to the main body frame 200 is restricted in the radial direction of the shaft member 361 by the bent portion 363b and the restriction portion 363d of the shaft supporting member 363 and the shaft cover portion 364b and the shaft cover portion 364c of the restriction member 364. Moreover, by the relative relationship between the lower ridge line portion 362d of the shaft supporting member 362 and the upper ridge line portion 363c of the shaft supporting member 363, even in the thrust direction of the shaft member 361, the front door 300 is relatively positioned with respect to the main body frame 200.

In a state in which the restriction member 364 has been attached to the shaft supporting member 362 and the shaft supporting member 363 coupled with each other, the middle portion of the shaft member 361 is arranged in a region surrounded by (1) the bent portion 363b of the shaft supporting member 363, (2) the restriction portion 363d of the shaft supporting member 363, (3) the shaft cover portion 364b of the restriction member 364, and (4) the shaft cover portion 364c of the restriction member 364. When the shaft member 361 and the shaft supporting member 362 turn according to turning of the front door 300, the shaft member 361 relatively turns with respect to the above-mentioned portions (1) to (4). In the radial direction and thrust direction of the shaft member 361, the relative position of the front door 300 to the main body frame 200 is restricted. Accordingly, the degree of freedom of the relative movement of the front door 300 to the main body frame 200 is only in the rotational direction centering on the extension direction of the shaft member 361. With such a configuration, the shaft member 361, the shaft supporting member 362, the shaft supporting member 363, and the restriction member 364 implement the function of the lateral hinge 340.

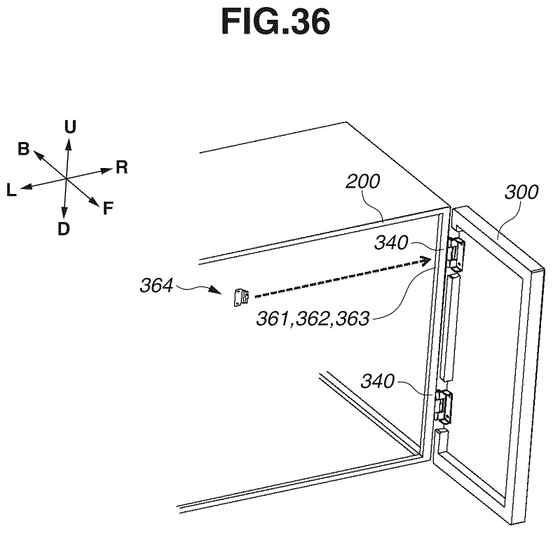

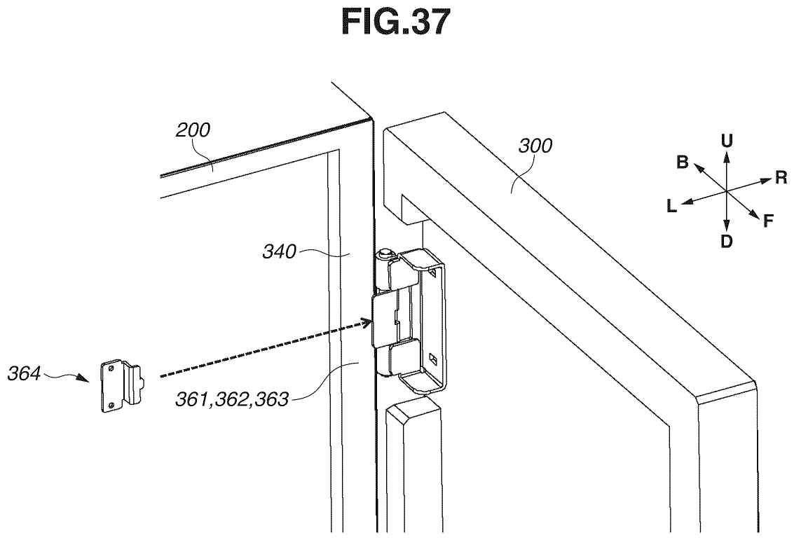

Next, the states of the front door 300 and the main body frame 200 occurring at the time of attaching the restriction member 364 are described. FIG. 36 is a perspective view illustrating the front door 300, the main body frame 200, and the lateral hinge 340. FIG. 37 is a diagram illustrating the enlarged view of a part illustrated in FIG. 36. Accordingly, the description about FIG. 36 also entirely applies to FIG. 37.

In a state in which the shaft supporting member 362 and the shaft supporting member 363 have been coupled with each other as illustrated in FIG. 34, the upper ridge line portion 363c of the shaft supporting member 363 is supporting the shaft supporting member 362. At this time, if an external force from the operator is not given to the front door 300, the front door 300 is in a state of being opened at an optional angle relative to the main body frame 200 and being still and stable. In a more precise sense, considering the working position and visibility taken when the operator couples the shaft supporting member 362 and the shaft supporting member 363 with each other, the front door 300 is coupled at the angular position where the front door 300 has been opened 90 degrees or more with respect to the main body frame 200, and, if no external force from the operator is given to the front door 300 after coupling thereof, the front door 300 becomes still and stable at such a door opening angle with respect to the main body frame 200.

As described above, coupling the shaft supporting member 362 and the shaft supporting member 363 with each other enables holding the front door 300 relative to the main body frame 200 in a state in which the front door 300 temporarily remains still. The state in which, in this way, no force is applied to the front door 300 excluding a force for supporting the front door 300 at, for example, the coupling portion and contact portion and a gravitational force which is applied to the front door 300 is referred to as “the front door 300 being in a free state”.

In the second exemplary embodiment, as illustrated in FIG. 36, when the front door 300 is in a free state, the shaft member 361, the shaft supporting member 362, and the shaft supporting member 363 of the lateral hinge 340 are exposed in some of the right-left direction. Thus, a region to which the restriction member 364 is attached is exposed via the inside of the image forming apparatus. Moreover, as illustrated in FIG. 35, the restriction member 364 is attached from some of the right-left direction. Therefore, it is possible to, while maintaining the front door 300 in a free state, attach the restriction member 364 to the shaft supporting member 362 and the shaft supporting member 363. Moreover, naturally, it is possible to, while maintaining the front door 300 in a free state, detach the restriction member 364 from the shaft supporting member 362 and the shaft supporting member 363. Thus, with the front door 300 being opened, i.e., with the front door 300 kept in a free state, the restriction member 364 is attachable to and detachable from the shaft supporting member 362 and the shaft supporting member 363. Such a configuration enables facilitating an operation for attaching the front door 300 to the main body frame 200.

Thus far is the description of the configuration of the lateral hinge 340 in the second exemplary embodiment. Next, a modification example of the lateral hinge 340 is described.

In the above-described second exemplary embodiment, the restriction member 364 plays the role of restricting the position in the radial direction of the shaft member 361. However, the restriction member 364 can be the one which restricts the position of the front door 300 relative to the main body frame 200 in an optional direction (for example, in the thrust direction). Additionally, the restriction member 364 can be configured to restrict the position not only in one direction but also in a plurality of directions.

Moreover, an example in which each member constituting the lateral hinge 340 is a single component which is formed from one piece of sheet metal subjected to bending work has been described. However, each of the shaft member 361, the shaft supporting member 362, the shaft supporting member 363, and the restriction member 364 can be formed from a plurality of components coupled with each other or welded with each other.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-065812 filed Apr. 15, 2024 and Japanese Patent Application No. 2025-008823 filed Jan. 22, 2025, which are hereby incorporated by reference herein in their entirety.

What is claimed is:

1. An image forming apparatus comprising:
an image forming unit configured to form an image on a sheet;
a conveyance unit configured to convey a sheet in a first direction which intersects with a vertical direction;
a main body frame configured to support the image forming unit and the conveyance unit;
an exterior cover arranged on a front side of the image forming unit with respect to a front-back direction which intersects with the vertical direction and the first direction, the exterior cover forming at least a part of a front exterior of the image forming apparatus; and
a hinge configured to couple the exterior cover and the main body frame,
wherein the hinge includes:
a first shaft supporting member attached to the main body frame;
a second shaft supporting member attached to the exterior cover;
a shaft member supported by the first shaft supporting member and the second shaft supporting member; and
a restriction member configured to restrict a position of the shaft member,
wherein the exterior cover is configured to open and close by pivoting around the shaft member, and
wherein the restriction member is configured to be attached to or detached from the first shaft supporting member and the second shaft supporting member in a state where the exterior cover is in a free state.

2. The image forming apparatus according to claim 1,
wherein the exterior cover is configured to pivot around a pivot axis positioned on an upper end side of the exterior cover, with the shaft member serving as the pivot axis,
wherein the exterior cover in the free state receives a moment generated by a self-weight of the exterior cover, causing the exterior cover in the free state to rotate toward a closed position with the shaft member serving as the pivot axis, and
wherein, when the exterior cover in the free state is at the closed position, the exterior cover in the free state contacts with the main body frame and receives a force balanced with the moment causing the exterior cover in the free state to be still and stable at the closed position.

3. The image forming apparatus according to claim 1,
wherein the exterior cover is configured to pivot around the pivot axis on an upper end side of the exterior cover, with the shaft member serving as the pivot axis, and
wherein, in a state in which the exterior cover is in the free state and the restriction member has been detached, at least a part of the first shaft supporting member and the second shaft supporting member is exposed when viewed from upward.

4. The image forming apparatus according to claim 1, wherein the exterior cover includes a transparent cover and a cover frame arranged in at least a part of a circumference of the transparent cover.

5. The image forming apparatus according to claim 4, wherein, in a state in which the exterior cover is closed, at least a part of the image forming unit is visible through the transparent cover.

6. The image forming apparatus according to claim 4,
wherein the main body frame includes a first support pillar and a second support pillar arranged at both sides in the first direction, each of the first support pillar and the second support pillar extending in the vertical direction,
wherein the image forming unit is arranged between the first support pillar and the second support pillar in the first direction,
wherein the cover frame includes a first cover frame portion facing the first support pillar of the main body frame, and a second cover frame portion facing the second support pillar of the main body frame, and
wherein the transparent cover is provided to extend from the first cover frame portion to the second cover frame portion.

7. The image forming apparatus according to claim 6, further comprising:
a maintenance unit configured to maintenance the image forming unit; and
a reading unit configured to read an image on a sheet formed by the image forming unit,
wherein the maintenance unit is supported by the main body frame to be arranged between the image forming unit and the first support pillar in the first direction, and
wherein the reading unit is supported by the main body frame to be arranged between the image forming unit and the second support pillar in the first direction.

8. The image forming apparatus according to claim 7, wherein, in a state in which the exterior cover is closed, at least a part of the image forming unit, at least a part of the maintenance unit, and at least a part of the reading unit are visible through the transparent cover.

9. The image forming apparatus according to claim 1, further comprising a gas spring configured to assist rotation of the exterior cover.

10. The image forming apparatus according to claim 1,
wherein the image forming apparatus includes a first module including the image forming unit and the conveyance unit, and
wherein the image forming apparatus further includes a second module coupled adjacently with the first module in the first direction and having a different function from that of the first module.
